(19) United States
(12) Patent Application Publication
(10) Pub. No.: US 2006/0115378 A1
(43) Pub. Date: Jun. 1, 2006

(54) Device for the continuous testing of materials

(76) Inventors: Torsten Zech, Heidelberg (DE); Alexander Cross, Britisch (DE); Oliver Kochel, Bubenheim (DE); Frank Gullich, Sandhausen (DE); Ralf Kuppinger, Plankstadt (DE)

Correspondence Address: Stephen D Scanlon;Jones Day, North Point, 901 Lakeside Avenue, Cleveland, OH, 44114, US

(21) Appl. No.: 10/538,597

(22) PCT Filed: Dec. 10, 2003
(86) PCT No.: PCT/EP03/14021

§ 371 Date: Sep. 30, 2005

(30) Foreign Application Priority Data
Dec. 11, 2002 (DE) 102 57 780.3

(51) Int. Cl. B01J 23/18; G01N 35/00; B01J 19/00

(52) U.S. Cl. 422/63; 502/353; 422/130

(57) ABSTRACT

The present invention relates to a device for the continuous testing of at least two building blocks, which are part of a combinatorial material library. Thereby, said device is in particular characterized in that it comprises at least the following constituent parts: (i) at least one spatially stationary component with at least one means for supply, (ii) at least one spatially non-stationary component as well as (iii) at least one unit for the uptake of a building block. Thereby, at least one building block moves spatially relative to the at least one other building block during the testing.

The present invention relates to a device for the continuous testing of at least two building blocks, which are part of a combinatorial material library. Thereby, said device is in particular characterized in that it comprises at least the following constituent parts: (i) at least one spatially stationary component with at least one means for supply, (ii) at least one spatially non-stationary component as well as (iii) at least one unit for the uptake of a building block. Thereby, during the testing at least one building block moves spatially relative to the at least one other building block.

The present invention is in the technical field of the high-throughput material research, in particular the high-throughput catalyst research. It is known that the implementation of high-throughput research increases significantly the efficiency and effectiveness of the discovery of new materials. Thereby, it is advantageous providing a device, which enables a preferably integrated process sequence, and which in particular comprises all essential sub steps of the high-throughput material research, as for example the testing and/or classification of materials.

The quick testing of solid materials, for example of heterogeneous catalysts, is until now mostly carried out in a manner that in a parallel reactor or on a solid substrate several materials, which are arranged in parallel, are exposed simultaneously to the test conditions and the performance properties of the materials are identified. During the testing, the relative position of the materials to be tested does not change towards each other. The counterpart of said arrangement in the biochemical high-throughput research is the micro titer plate.

In either case a plurality of materials, which possibly is on a support substrate, is inserted into a test equipment, and subsequently a test program is started. For example, such parallel, non-continuous methods for the testing of materials as well as the related devices are described in the WO 98/15969, in the DE-C 198 09 477 as well as in the DE-A 101 17 274. Thereby, devices can be distinguished, in which the materials to be tested are stationary on a substrate or are in appropriate cavities. The devices, which comprise a substrate, have the drawback, that the materials cannot be investigated independently from the substrate. Dependent on structure and properties the manufacture of the substrates possibly is associated with considerable costs, what in particular is therefore a drawback as the substrate cannot be reused when depositing materials directly on the substrate.

By using test equipments with suitable cavities said materials must be inserted manually or automatically into said cavities and must be removed again after the test, whereby, as a rule, an additional cleaning of the cavity is necessary. Therefore, the testing of materials in the above-mentioned devices is not carried out continuously in the meaning of the present invention, because the building blocks to be inserted into the test equipment are arranged in a spatially stationary position and do not change their position towards each other. In particular, it is not possible replacing one building block by another one during the test procedure. Moreover, the building blocks can always only be replaced in the complete reaction procedure (batch wise).

If, for example, thousands of building blocks are to be tested, and only a common multi-reactor (16-, 49-, 96-fold) is available, then the testing can be very time-consuming, in particular, if for each new feeding the complete equipment must be opened, rinsed, possibly cleaned and then sealed again, must be checked for pressure-tightness, and possibly a steady state condition must be adjusted. Therefore, all in all, a relative large time-consumption results, which is necessary for the testing of materials when using discontinuously working devices. Therefore, the testing of materials in discontinuous working devices requires an overall time-consumption of one to several minutes per material to be tested, even if very fast chemical methods of analysis are applied.

One possibility for the reduction of the test period or the reduction of the period for the necessary preparing and follow-up steps was introduced by Muhler et al. (S. Geissler, H. Zanthoff, M. Muhler: “Oxidative Dehydrierung von Ethylbenzol zu Styrol—Katalysatorentwicklung unterstutzt durch schnelles kinetisches Sreening, Proceedings” XXXIV. Jahrestreffen Deutscher Katalytiker in Verbindung mit dem Fachtreffen Reaktionstechnik, 21.-23. Marz 2001, Weimar). In order to achieve a fast change of the catalyst to be tested, a carousel fitted with individual reactors was automatically positioned into test position. By turning the carousel for one unit, thereby a new catalyst reaches the test position, respectively. However, the number of the catalysts to be tested is limited to the number of the positions within the carousel. Moreover, the catalysts are already in a reactor, which is sealed off. The feeding as well as the depleting of the reactors has still to be carried out manually. Therefore, said test is a non-continuous, sequential test of catalysts, which is accelerated by means of an automated process, whereby the catalysts are present in individual units of the reactor.

Another approach for the exchange of catalysts in catalytic test reactions was described by Jensen et al. (Losey, Schmidt, Jensen: “Micro-fabricated multiphase packed-bed reactors: Characterization of mass transfer and reactions”, Ind. Eng. Chem. Res. 40 (2001) 2555-2562). Thereby, by means of special connections for fluids, a solid catalyst, which is present within a micro reactor in the form of a bulk material, can be supplied and blown out pneumatically. However, said solution merely targets at the possible reuse of the micro reactor and not at the quick test of the catalyst. In turn, the test of the catalyst per se is carried out in the described non-continuous manner.

A device for the continuous identification of already labeled multi-cellular organisms and their sorting for pharmaceutical applications is described in the WO 00/11449 (“Instrument for selecting and depositing multi-cellular organisms and other large objects”). Accordingly, the organisms resp. objects to be analyzed are suspended in a suitable liquid, and are directed individually through an analysis zone (sensing zone). Dependent on the result of the analysis, a discharge of objects resp. a put-down of selected objects can be carried out, for example in micro titer plates. Thereby, the analysis relates to the identification of predetermined characteristics, for example of the fluorescence of the objects to be tested. It is also described that the characteristic to be identified can be of chemiluminescent, phophorescent, magnetic or radioactive nature.

By means of the device, which is described in the WO 99/11449, the range of the application of the “flow cytometry” was extended to multi-cellular organisms and micro support matters of the combinatorial pharmaceutical research. However, no teaching is given, how the (chemical) properties of materials can be investigated by means of the presented method. It is characteristic for the mentioned device that the biological samples to be sorted move during the complete process on a single fluidic path, whereby the fluid is at the same time the transport medium. The described instrument does not work without said transport medium. Said requirement restricts considerably the application range of the described instrument. That means, for example, that the organisms and micro support matters to be sorted are exposed to said support fluid the whole time, whereby the interaction between the fluid and organism resp. micro support matter cannot be investigated. Also, it is not possible to apply in different phases of the experiment different fluids, what would be of crucial relevance for a detailed testing of materials. Therefore, the described process resp. instrument can merely be applied to the sorting of organisms or micro support matters.

Since years for the quick (chemical) analysis of liquid samples so-called “serial analysis systems” or “flow-injection systems” are applied in the field of biotechnology, which are run continuously (for example see the WO 00/42212, “Optimized high-throughput analytical system”). The principle of said analysis systems is that different samples of liquids are transported serially, that means in succession, through an analysis system, and one or several properties of the samples are detected at a geometrical defined position within the flow system by means of appropriate, mostly optical methods. However, the different systems, which are described in the literature do not give any hint, how the analysis of the properties of samples (building blocks), which are solids, can be carried out.

Thereby, it is desirable to provide a continuous process for the testing of materials, because thus the drawbacks of discontinuous processes can be eliminated totally or partially. Moreover, there is a high demand for a device, by means of which said material libraries with a very large number of building blocks (>10³-10⁶ building blocks) can be tested within a very short period, for example within one second per building block. Furthermore, it could, or better it had to be worked without the presence of a substrate in a continuous working device for the testing of materials.

According to the state of the art, in discontinuous devices for the testing of materials, as a rule, material libraries are employed, in which the materials to be tested are in a solid, defined one, two or three dimensional arrangement on a substrate. Consequently, as a rule, all sub steps, which are carried out with said device within the scope of said test procedure, have to be adjusted to said geometry of the library. Furthermore, this has the drawback that always all building blocks have to be handled simultaneously on one substrate.

Therefore, an object of the present invention was to provide a device for the testing of materials, which is an alternative to the discontinuous working devices, which avoids or attenuates the drawbacks of said discontinuous devices, and which, in particular, allows testing building blocks more efficiently than it is possible according to the state of the art, or allows testing a higher number of building blocks than it is possible according to the state of the art

An advantage of a continuous or quasi-continuous working device for the testing of materials is to become independent from a particular library geometry, and therefore to achieve a higher flexibility by investigating the materials to be tested. Thereby, it is possible, to subject the individual materials of an existing library to different operations and/or different combinations of operations in dependence on a preceding test result according to a chemical-mechanical logic, in the meaning of logical control, consequentially forming sub sets of solids of the library, and so realizing different test algorithms for different materials.

Thereby, a device is of particular advantage, in which the building blocks are not associated permanently with a substrate, thus can move relatively towards each other. A device, which is not limited to a substrate, allows an essential higher flexibility in the testing of the building blocks. So, for example, it is possible to reduce the number of the building blocks after a first test for a performance property, because only those ones are further on regarded, which fulfill the requirements of the first test. Herewith, crucial advantages concerning the necessary space and time requirements are realized.

The present invention relates to a device for the continuous testing of at least two building blocks, which are part of a combinatorial material library. The building blocks can be the same or can be different. Thereby, in particular, the device of the invention is characterized in that it has at least the following constituent parts:
(i) at least one spatially stationary component with at least one means for supply;
(ii) at least one spatially non-stationary component;
(iii) at least one unit for the uptake of a building block,
wherein the position of at least one building block relative to the at least one other building block changes during the testing.

In a preferred embodiment, the geometry around one building block changes, what means that position and/or form of the geometric environment of one building block changes, for example in such a way that the geometry of the reaction space changes. Thereby, the reaction space is either the unit for the uptake of the building block or a combination of the unit for the uptake with at least one other constituent part of the device of the invention.

Furthermore, it is preferred that during the testing one property change of at least one building block is induced, whereby said property change can be of chemical, physical or physical-chemical nature.

The procedure, which can be carried out with the device of the invention, is described in the DE 101 59 189.6, the content of which is fully incorporated by reference in the context of the present invention. In this context the device of the invention should preferably allow carrying out at least one of the following operations with the building blocks to be tested, whereby the operations can be arbitrarily permutated and/or repeated:
at least one test operation, in which at least one building block is tested for at least one performance property;
at least one storing operation;
at least one rating operation;
at least one classification operation;
at least one conditioning operation;
at least one transport operation.

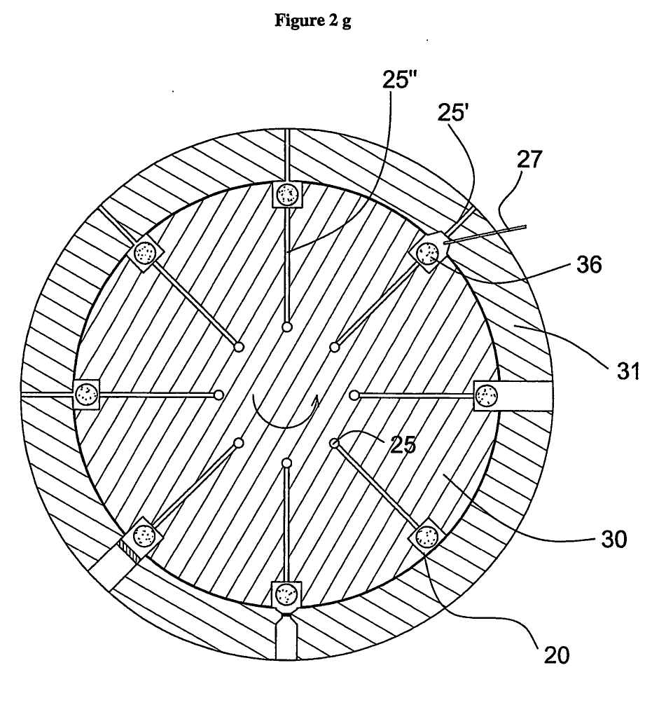

Preferably, according to the invention, the testing of building blocks for their performance properties is carried out in a unit for the uptake, further preferred in a reaction space, whereby the geometric form and/or size and/or position in the space of the unit for the uptake resp. the reaction space can change before, during or after a step or an operation, that means is changeable in its geometric design. The unit for uptake can form the reaction space alone or in the interaction with other components of the space resp. parts thereof, in which the building block can, for example, be conditioned or tested (see for this also FIG. 2).

Preferably, the device is designed in a manner, that negative impairments during the lead-through of operations in one part of the device cannot be transferred to another part of the device. For example, it is guaranteed that undesired pollution cannot be transferred from one part of the device to the next part of the device. By means of such a realization a cross-contamination of the test results between different building blocks of a library can be avoided resp. minimized.

The materials, the device of the invention can be composed of, are selected in a manner that they are compatible with the problem to be solved resp. to be investigated in the testing and/or production of the building blocks. This means that by the lead-through of catalytic investigations, for example materials are selected, which are inert resp. are widely inert, as well as provide a sufficient temperature and pressure stability. If different materials are used, then it is preferred that said materials are compatible with each other, that means that they do not react with each other or that they have similar thermal coefficients of expansion, so that during heating up or cooling down no undesired stress can occur. Contrary, the combination of the materials can be just selected in a manner that by thermal expansion a desired effect can be achieved, for example a sealing effect.

In a preferred embodiment the materials are in particular inert with respect to the fluids to be applied for the continuous testing, for the temperatures to be applied, respectively, as well as with respect to the resulting or adjusted pressures. In particular, to be inert should avoid that parts of the device are reduced in their function as well as that building blocks are contaminated and/or test results are falsified. In a preferred embodiment the materials are compatible with the method of analysis to be applied for the testing. For example, if IR-thermography procedures are applied, then preferably at least one part of the device is made from an IR-transparent material.

Therefore, with regard to the concrete materials to be applied, no principle restrictions exist, as long as the before-mentioned conditions are fulfilled resp. are partially fulfilled. For example, materials are mentioned as follows: stainless steel, in particular V2A-steels, heat-resistant and corrosion-resistant steels, hardened steels; noble metals, alloys, hard metals and hard metal alloys, in particular Hastalloy®, Inconel as well as titanium alloys; silicon, silicon dioxide as well as composite materials, which contain silicon; plastics, in particular heat-resistant and corrosion-resistant plastics as for example Teflon (PTFE), PEEK, etc.; glasses, ceramics, in particular oxidic ceramics or carbide ceramics, carbon composite materials, etc.; mixtures, blends or composite materials made from one or more of the before-mentioned materials are also possible. In this context, in particular also the relevant content of the DE-A 100 36 633 is fully incorporated by reference in the present invention.

In preferred embodiments micro-structured components and/or combinations of micro-structured and macro-structured components are applied. In a miniaturized embodiment nano-components resp. particles and/or nano-structured materials can be applied.

Generally, devices with low or no clearance volume as well as with very short transport ways as well as with low reaction volumes are preferred, in order to reduce the test rate, that means the test period being necessary per building block, and thus optimizing the total test procedure with respect to the rate. Said procedure has the advantage that the rate-determining step in the testing of the building blocks is reduced to the intrinsic behavior of the building blocks within the test. So, for example, the period can be reduced, which is necessary for the adjustment of an equilibrium condition, or of a minimal reaction time for the observation of a property under conditions, which can be scaled up, and which perform a considerable contribution for the understanding of the behavior resp. the properties of the tested building block.

Furthermore, the device of the invention optionally comprises the following constituent parts:
at least one means for the analysis of at least one performance property;
means for the storing of at least two building blocks;
means for the selection of at least one building block from at least two building blocks;
means for the recording and analyzing of data;
means for the transport and/or for the substrate-less transport of at least one building block;
means for the classification of at least one building block;
means for the mounting;
means for power transmission;
means for drive;
means for the adjustment of parameters P;
means for the removal of subsequent products or by-products;
means for the fluidic sealing.

In a preferred embodiment, the device of the invention is fitted with means, which allow removing or separating off by-products or subsequent products or other unwanted substantial impairments, which are produced during the lead-through of operations. For example, this relates concretely to the defined discharge of abrasion of the building blocks to be tested and/or mechanical moved parts of the device as well as to the discharge of condensed or crystallized reaction products or the like.

Furthermore, the present invention relates to a device for the continuous conditioning and production or the continuous conditioning or production of building blocks, which can be the same or can be different from each other, of a substance library, at least comprising:
(i) at least one spatially stationary component with at least one means for supply,
(ii) at least one spatially non-stationary component,
(iii) at least one unit for the uptake of a building block,
wherein the position of at least one building block relative to the at least one other building block changes during the continuous production and/or conditioning.

The device of the invention is preferably used for the lead-through of the process of the invention for the continuous testing and/or production of heterogeneous catalysts.

In the following, the terms, which are used within the context of the present invention, are defined, and the preferred embodiments connected therewith are mentioned.

Sealing, means for fluidic: Means for the fluidic sealing in the meaning of the present invention is any means, which reduces and/or stops the fluid stream between a stationary and a non-stationary component at at least one position (in comparison to the fluid stream, which would exist without said means for the fluidic sealing). Preferably, the means for the fluidic sealing (seals) are at those positions, where a fluid stream is undesired, as for example at the lateral pressings between stationary and non-stationary component, if one building block should be flowed through perpendicular to said direction.

In principle, there are no restrictions concerning the means for the fluidic sealing to be employed, as long as the above-mentioned conditions are fulfilled, and the material, said means is made from, is inert under the desired conditions and stress, in such a way, that the function of the device is not impaired significantly. For example, such means for the fluidic sealing can be: the pressing of polished or otherwise treated surfaces, in particular of metal surfaces, the use of seals, seal rings, in particular of O-rings, metal-rings, graphite, lubricants, Teflon etc.

Analysis, means for: An “analysis” in the meaning of the invention is the use of at least one analysis technique for the testing of materials within a material library for the identification of the property characteristics thereof, for example performance properties. Preferably, the means for analysis of at least one building block include at least one technique for analysis. The term “analysis” and “means for analysis” are equivalent in the context of the present invention.

Fundamentally, the detecting of chemical, physical or physical-chemical properties for the analysis for particular (performance) properties is possible. For example, said properties can be of magnetic, electric, dielectric, electromagnetic and/or piezo-electric nature. As method for analysis any method can be applied, which indicates within the scope of the device of the invention a change of at least one property of the material to be tested. In particular, it is preferred applying quick methods for analysis. In principle, the analysis of the building blocks for performance properties can be carried out parallelly as well as sequentially.

Here, the following techniques for analysis are exemplified: infrared thermography, mass spectroscopy, chromatographic techniques like GC, LC, HPLC, micro-GC, rapid-GC, dispersive FTIR-spectroscopy, microwave-spectroscopy, Raman-spectroscopy, NIR, UV, UV-VIS, NMR, ESR, GC-MS, infrared-thermography/Raman-spectroscopy, infrared-thermography/dispersive FTIR-spectroscopy, color detection with chemical indicator/MS, color detection with chemical indicator/GC-MS, color detection with chemical indicator/dispersive FTIR spectroscopy, photo acoustic analysis, electronic or electrochemical sensors as well as tomographic NMR- and ESR-methods. Furthermore, combinations of two or several of the presented methods for analysis are possible as well as paralleling, as for example parallel gas chromatography. In particular, within this context it is preferred applying combinations of IR-thermography and mass spectroscopy as well as IR-thermography and GC-MS.

For example, it is possible carrying out in or at the device infrared-thermography with correction of emission (see for example the WO 99/34206). Here, the development of the temperature of the individual building blocks in the device can be depicted from the recorded infrared picture, preferably with digital picture processing. In case of a low number of building blocks, optionally a temperature sensor can be assigned to each individual building block, for example a pyrometric element or a thermal element.

Uptake, unit for: The device of the invention comprises mendatorily at least one unit for the uptake of building blocks. Thereby, the term uptake defines the locating of at least one building block in a defined geometric environment during a defined time period, preferably during the lead-through of at least one operation resp. one process step (for example transportation, conditioning, etc.). Thus, in this meaning an “unit for uptake” of a building block is any well-defined geometric environment of a building block.

The unit for the uptake can already present per se a reaction space in the meaning of the present invention. However, it is preferred that a reaction space consists of a unit for the uptake as well as of at least of one other constituent part of the device, preferably a part resp. a sequence of a stationary component. In the meaning of the present invention said reaction space is preferably changeable in its geometric design. That means preferably that the geometric form, size and/or position of the reaction space are variable. For example, said variability can be achieved by means of the movement or shifting of constituent parts of the device.

There are no principle restrictions concerning the exact design of a unit for the uptake, as long as the unit can fix a building block in a way that the building block does not move significantly relative to other constituents of the device, except in such a case, as this is desired or determined in the meaning of the process, which is carried out with the device, for example during the further transporting or discharging of the unit.

For example, such a unit for the uptake can be a recess, which is positioned on a rotatable body. The recess can be a blind hole or a recess, which is tapered continuously or cascadedly. In a preferred embodiment, the unit for the uptake is designed in a way that the building block seats punctually on a connecting piece, whereby the connection piece is part of the recess or is formed by means of a recess.

Furthermore, it is preferred that the geometry of the unit for the uptake is designed in a way that within the unit during the flowing through with a gas flow conditions result, which are steady state or quasi steady state or close to steady state conditions. Furthermore, it is preferred that said flow conditions correspond to the conditions, as they exist within a tubular reactor. For example, said conditions can thereby be achieved by means of the punctual seating of the building block on a connecting piece, whereby the diameter of the connecting piece is from 35 to 95% of the diameter of the unit for the uptake and further preferred from 45 to 85%. Very generally, each realization of the unit for the uptake is preferred, in which in case of presence of one building block within the unit for the uptake as well as in case of the flowing through of the unit with a gas (via the means for supply and/or discharge) Bodenstein-identification numbers are achieved being more than 2, preferably more than 5, further preferred more than 20.

In connection with the embodiment of the unit for the uptake resp. the reaction space, here the relevant disclosure of the DE-A 101 17 275 is fully incorporated by reference.

Preferably, the interaction between the unit of the uptake of a building block as well as the other parts of the device of the invention is given by the following: at first, a building block is inserted into the unit for uptake, for example by means of an accurate bringing into contact of the open side of the unit for the uptake with a means for the supply of building blocks. Said means for the supply of building blocks must have a size, which at least relates to the size of the building blocks. After the feeding the rotatable body is moved further (transport operation) until the unit for the uptake of the building block (now with the building block) contacts another supply, for example a supply of gas. Said supply can be a wall with a recess for the inlet of the gas, wherein the recess can be smaller than the building block, and, indeed, typically is smaller. Herewith, the geometry of the reaction space of a building block has changed during an operation within the scope of the testing (see FIG. 2).

In the meaning of the present invention it is not excluded, and for certain processes for the continuous testing of materials it is absolutely preferred that more than one building block per unit for the uptake of one building block is existent. For example, this applies, if as means for the analysis an IR-thermographic process is used, which allows discriminating building blocks within a unit for the uptake.

Selection, means for: The device of the invention optionally has at least one means for the selection of at least one building block from a set of at least two building blocks. Typically, said selection is combined with a transport of at least one building block. By the lead-through of the selection (operation) all known mechanical or physical methods for the selection of building blocks out from a set of building blocks can be applied, which are known to the one skilled in the art, and which are suited creating discrete sub sets and separating said sub sets from the starting set. Preferably, pneumatic transport methods (applying overpressure or low pressure), elements to be moved mechanically, optical forceps, acoustic fields, electrostatic methods, magnetic methods, piezo-elements, gravitation and the like, as well as combinations of the before-mentioned methods are applied. With respect to the mechanic methods, it is preferred using wheels, combs, conveyer belts, screws, “revolving doors”, pickers, metering devices, and the like.

Preferably, the mentioned methods are applied in a defined time interval, until the required sub set is formed. Subsequently, said sub set is preferably processed or transmitted with a means for transport.

Preferably, the means for the selection is constructed in a way that from a set M with a number of N building blocks one or several building block(s) is/are selected randomly or in a defined manner, and optionally is/are transferred to a means for transport. A means for selection of exactly one building block is denominated in the meaning of the present invention also as “means for separating”.

Preferably, during the complete selection process the selected building blocks are in a defined condition, preferably a steady state condition. Thereby, it is further preferred that said condition is a steady state condition with respect to the reaction technique. For example, this can be established by overflowing the selected building blocks during or before the selection completely or also in sections with fluids for conditioning and/or reaction by using at least one means for the supply, by being under a defined pressure, and/or are tempered in a defined manner, also in sections. Herewith, it is established that the building blocks are already in a condition when being transferred to the next operation, which is desired therein.

Building block: The term building block denominates an individual defined unit, which is individually or in groups (sub sets) within the device of the invention, and which can consist of one or several constituents resp. materials. The materials the building block preferably is made from, are within the context of the present invention non-gaseous substances, as for example solids, liquids, sols, gels, waxy substances or mixtures of substances, dispersions, emulsions or suspensions, whereby solids are particularly preferred.

Thereby, the substances to be applied for the building blocks within the context of the invention can be molecular and non-molecular chemical compounds resp. formulations, resp. mixtures resp. materials, whereby the term “non-molecular” defines substances, which can be varied continuously resp. changed continuously, contrary to “molecular” substances, whose structural characteristic can merely be changed by means of a variation of discrete conditions, thus, for example, by means of the variation of a substitution pattern.

The composition of the building blocks comprises both the stoichiometric and the substance composition and element composition of the materials to be tested, which can be different from material to material. Therefore, it is possible according to the invention producing material libraries resp. testing material libraries, which consist of materials, which are namely identical with respect to their element composition, however, whereby the stoichiometric composition of the elements, which determine the material, is different between the individual materials; furthermore, it is possible that the material library is built up from building blocks, which are different with respect to their element composition, respectively; naturally, it is also possible that the individual materials are different with respect to their stoichiometric composition and element composition, respectively. Further, it is possible that the material library is built up from building blocks, which are identical with respect to their element composition and stoichiometric composition, however, which are different with respect to the physical or chemical or physical-chemical properties as a consequence of a treating step. Thereby, the term “element”, which is used here, relates to elements of the Periodic Table of the Elements. Here, the term “substance” means materials, constituents or precursor-constituents, which result in a material.

In principle, the type of building blocks to be applied can be varied user-defined (as long as said building blocks, for example, comply with determined geometric requirements) within the device of the invention. The type of the building blocks, which for example are inserted by means for supply during the continuous testing into the device, can also be changed resp. alternated during the continuous testing. So, for example, it is conceivable that at first catalyst-beads are inserted, however, in the following process micro-containers with powders.

For example, building blocks according to the invention can be: heterogeneous or heterogenized catalysts, luminophors, thermoelectric, piezo-electric, semiconducting, electro-optic, superconducting or magnetic substances or mixtures of two or more of said substances, in particular intermetallic compositions, oxides, mixtures of oxides, mixed oxides (for example mixtures of two or more oxides), ionic or covalent compounds of metals and/or nonmetals, metal alloys, ceramics, organometallic compounds and composite materials, dielectric fluids, thermoelectric materials, magneto resistive and magneto optical materials, organic compounds, enzymes, and mixtures of enzymes, pharmaceutical agents, substances for feed and for additives for feed, substances for food and for additives for food, cosmetics.

It is also possible, and indeed it is preferred within the scope of the catalyst research, that by means of a suitable different composition of elements a plurality of materials per building block is existent, which are in fact largely similar, however, which differ in at least one element, and therefore, as many material variants as possible or all material variants of a mixture can be tested.

The building blocks to be applied, respectively, can be the same among each other or can be different with respect to their (chemical) composition, wherein the latter is preferred. The building blocks can be the same or can be different with respect to their appearance or geometric characteristic, wherein the first is preferred. Sub sets of building blocks can also be grouped on and/or in suitable devices, and can then preferably be applied to a continuous test process.

For the manufacture of the building blocks all processes for the manufacture can be applied, which are known to the one skilled in the art. For example, such processes for the manufacture are known from the combinatorial material research. In particular, in said context reference is made to “Verfahren zur Herstellung einer Vielzahl von Bausteinen einer Materialbibliothek”, which is described in the DE-A 100 59 890, and which is fully incorporated in the context of the present application. Likewise, it is also made reference to the processes for the manufacture, which are described in the DE-A 100 42 871 as well as in the WO 99/59716.

The manufacture of the building blocks can be carried out outside as well as inside of the device of the invention, whereby it is also conceivable carrying out a partial manufacture or premanufacture outside of the device of the invention in combination of a manufacture within the device of the invention, in particular, with respect to the aspect that a building block can also be built up from several constituents. It is preferred manufacturing the building block outside of the device of the invention and conditioning said building block inside of the device of the invention.

In a preferred embodiment of the present invention the building block of the library is a defined shaped body with any shape, for example ball, monolith, cuboid, polyedric body, cylindrical body, for example realized as “bead”, “pellet” or “tablet”. Thereby, the body has to be applied in a mechanic stability, which is sufficient for the process steps to be carried out in the device of the invention. A building block can be composed of a plurality of similar or different individual bodies.

If the materials to be tested are heterogeneous catalysts, preferably ball-shaped full catalysts, ball-shaped shell catalysts or ball-shaped supported catalysts are applied. The diameter of the ball-shaped building blocks is preferably in the range of from 1 μm to 50 cm, further preferred in the range of from 10 μm to 2 cm and in particular preferred in the range of from 100 μm to 5 mm.

In another preferred embodiment the shaped bodies have a metallic core or are otherwise magnetized, so that for the transport and for the handling of the building blocks one or more magnetic fields can be applied.

In another preferred embodiment it is possible to check by means of the present invention also powdery materials or bulk materials for their performance properties. In order to transport such a powder in a simple manner, and in order that such a powder can also be present in neighborhood with other building blocks, such building blocks are preferably in special means for the storing, for example containers for building blocks, which allow a supply and discharge of fluids, electromagnetic radiation, etc., to the building block. Additionally, the containers resp. the means for the storing of the powders can be equipped with membranes (for appropriate embodiments of the membranes see DE-A 101 17 275). Said means for the storing have to be formed in a way that they can both carry the plurality of building blocks (powder) and have to fit into the units for the uptake of the non-stationary component of the invention.

Said containers can be described as geometric bodies. Thereby, such a container, which in this case is at the same time a building block, preferably is a geometric body, whose maximum radius is between 1 mm and 20 cm, measured from the geometric balance point. In a preferred embodiment said containers are equipped with frits or membranes. The containers can be open or sealed, whereby in case of sealed containers in preferred embodiments actions can be taken, in order to reopen the containers after the termination of the test procedure. Besides, it is possible, carrying out for individual test operations an automatically opening of the containers, in order to carry out a test with respect to a preferred performance property, for example an XRD-characterization of a powder (powder-diffraction). After the termination of such an operation the container can be resealed and can be transmitted to the next operation. An example for a special embodiment of the containers are the Kan™-reactors, which are commercially available from the company Irori, San Diego, Calif.

In a special embodiment of the invention, powdery materials are used in containers, which were synthesized directly inside of the containers, for example by applying the process as described in the DE-A 100 59 890. In another preferred embodiment, the containers are in addition equipped with a feature, which allows a clear identification of the container and/or the material being therein. Preferably, for such a coding such methods are applied, which are inert during the lead-through of the process, and which are sufficiently stabile with respect to the conditions of the environment to be applied. Examples for such methods are both described in the DE-A 101 17 274 and the DE-A 101 17 275, which are fully incorporated in the context of the present application by reference.

Within this context it has to be noted that also building blocks, which are not in a container, can be equipped with a coding for the identification of the building block. Examples for such methods are also described in both the DE-A 101 17 274 and the DE-A 101 17 275, which in this regard are fully incorporated by reference in the context of the present application.

Component: In principle, each bodily determined constituent part of the device of the invention is a component in the meaning of the present invention. Thereby, it has to be differentiated between stationary and non-stationary components. A stationary component remains spatially unchanged during the lead-through of the process, in particular here during the testing, which is carried out according to the invention by means of the device, that means it does not change its relative position with respect to a fictive inactive point of reference outside of the device of the invention. Accordingly, a non-stationary component is characterized in that it changes its spatial position with respect to said point of reference, at least partially.

With respect to the materials, the components are composed of, which constitute the device of the invention the same is true what is written above with respect to the materials of the device per se. It is preferred that both the stationary component and the non-stationary component are on their part composed of several constituent parts, respectively.

Mounting, means for: Means for mounting in the meaning of the invention is each means, which connects at least one part of the device, in particular a component, with at least one further part of the device, in particular another component. It is preferred that said connection is formed in a way that it can be redetached after the use according to the invention. Furthermore, the connection is formed in a way that it resists the conditions, which exist during the continuous testing. Otherwise, there are no principle restrictions with respect to the means for mounting. As examples for means for the mounting, which can be detached mechanically and reversibly, are mentioned: screws, connections, pins, threads, which are embedded into components, clamps, clips, springs, etc.

In principle, means for mounting are also conceivable, which are not detachable mechanically, as for example adhesions, welding, bonding, contacting, pressing, clenching, etc. In the meaning of the present invention also such means are included, which hold parts of the device in a determined position and simultaneously ensure or promote a movement between at least two components. Such means for mounting are for example bearings, in particular ball-bearings, sliding and/or adherent layers (lubrications, in particular with graphite or hard metal sulfides, for example molycote™).

Storing, means for: Optionally, the device of the invention has at least one means for storing of at least two building blocks. This comprises the storing and/or storage of a defined amount of building blocks of a material library in a defined geometric form/receiver (for example reservoir or receiver) under defined conditions. If the storing is carried out in combination with a conditioning step, additional actions can be taken, which avoid a negative influence between the building blocks, for example adhesions. For example, mechanical agitation, rinsings, rinsings for the discharge of abrasion, targeted discharge of undesired products, for example branching off of condensates and the like, are possible.

The building blocks of the material library can be spatially within the means for supply in a random or addressable manner, for example as fluidized bed in floating or in agitators by means of vigorous mixing or ventilation with, for example, compressed air or gas. The storing is typically in the beginning of the process, which is carried out by means of the device of the invention. So, for example, a building block can be taken from a (conditioned) reservoir and can be transferred into a unit for the uptake of the building block. Then, within this unit the building block can be conditioned continuously, can be tested, can be rated, etc. Preferably, a building block is transported by means of a means for the selection from the means for storing to another part of the device according to the invention.

Rating: It is possible by means of the device of the invention to rate one or more building blocks with respect to at least one performance property. The rating (rating operation) is to rate one or more recorded values to be measured during the testing by means of a means for analysis, for one or more building blocks relatively to one or more defined reference values, or absolutely, and to draw from said rating a logical conclusion for the further operation sequence of the test algorithms for the one or for the building blocks to be tested. The operation of a rating typically uses both the at least one means for analysis and a means for the recording and interpretation of data.

Preferably, the rating operation is carried out by means of interposing the means for the recording and interpretation of data, however, can also be realized directly as response to a value, which has been obtained by means of a means for analysis, for example, mechanically, for example by response of a bimetal to a change in temperature, which is caused by a building block within the test for a performance property, or also electrically, for example by means of an electric switch, which responds only, if a particular voltage value is achieved as response to a measured performance property of a building block.

An essential consequence of the rating is the assignment of a building block to a particular class. Said consequence can result in further operations, for whose implementation other means can be necessary, in particular means for the transport and/or means for the classification. In a preferred embodiment, the geometric classification takes place by means of a conditional transport operation of the building block to a building block class within a reservoir. Another preferred logic consequence is the conditional coding of a building block within a classification operation, for example by marking the building block with fluorescent agents or radioactive substances.

Another possible consequence of the rating is the conditional change of the parameter set P of the test operation. This means that in a preferred embodiment the building block is directly and subsequently subjected to another test in the same reaction space with changed test conditions (with new parameter set P) by fulfillment of a defined test criteria, for example a degree of conversion, which has been achieved in a chemical reaction.

In another preferred embodiment, the consequence of a rating can be that by fulfillment of a defined test criteria, for example a conversion degree, which was achieved in a chemical reaction, besides the first means of analysis, which was applied in the first test (for example infrared thermography) another means for analysis for the more detailed analysis of the product mixture is applied, for example a mass spectrometer.

The physical assignment of building blocks to a corresponding class subsequently takes place to the rating by means of a classification operation. If the rating operation is carried out in dependence on the composition of the material of the building block to be tested (if, for example, the test operation(s) comprise(s) such a characterization), it is not in each case necessary carrying out a physical assignment of the building blocks. In a preferred embodiment, the result of the rating is assigned to the material composition of the building block and not to the building block per se, and said relation is displayed and/or saved in electronic form, which is well known to the one skilled in the art.

Property characteristic: The term property characteristic denominates physical, chemical or physical-chemical conditions of the individual materials within the material library; examples are: oxidation stage, crystallinity, composition, structure, coordination geometry, etc.

By means of the possibility of the contacting of the building blocks with fluids and/or electromagnetic radiation, as for example magnetic fields, light, UV-VIS, X-ray radiation, microwaves, etc., a plurality of performance properties can be tested, which give informations, whether the building blocks are suitable catalysts, thermoelectric materials, superconductors, magneto resistive materials, etc.

Adjusting of the parameter set P, means for: According to the present invention, means for the adjusting of the parameter set P are all means by means of which at least one of the parameters, which can be changed during the continuous testing, is (i) adjusted, (ii) controlled, (iii) operated and/or (iv) regulated. User-defined combinations and/or sequences for adjusting, controlling, operating and regulating are also included. There are no restrictions with respect to the parameters, unless said parameters can change or can be changed during the continuous testing. Examples for such parameters are temperature, pressure, partial pressure, fluid composition, flow rate of the fluid, presence of magnetic or electromagnetic fields, etc.

For example, a means for adjusting the parameter set P can be a thermal element, which measures the temperature, that means which controls the temperature. Such a means can also be a combination of thermal element, computer and heating candle, wherein the thermal element measures the temperature, the computer compares the temperature with a target value and, as the case may be, controls a heating candle, whose heating power can be increased or decreased. Such a combination combines the tasks of control, of the adjustment, and of the regulation and controlling.

Recording and interpretation of data, means for: According to the present invention, means for recording and interpretation of data are all means by means of which data, and thereby, in particular, results of a means for analysis or parameter P, are (i) recorded, (ii) analyzed or (iii) processed for the controlling of operations within the scope of the continuous testing of materials. Any combinations of (i) to (iii) are included explicitly. In particular, the means for recording and interpretation of data are both used for controlling and regulation and automation of individual steps of the complete process for the continuous testing of materials.

Typically, said means are realized as micro processors (chips), which are at or inside of the device, or preferably, as a data processing equipment (computer), which is located in a central position, also outside of the actual device, and which typically has a processor as well as means for program coding (software).

Fluid: A fluid in the meaning of the present invention is any substance, in which the elementary parts, which build up the substance, for example elements or molecules, but also agglomerates thereof, moves towards each other, and in particular do not have any distant regularities towards each other. For example, said fluids are liquids, gases, waxes, dispersions, fats, suspensions, molten masses, powdery solids, etc. If the medium is in liquid form, fluids can also be multiphase liquid systems. In each case all mixtures of the above-mentioned substances are also included.

Classification, means for: The device according to the invention comprises optionally at least one means for classification of at least one building block. In the classification operation, which is carried out by means of the means for classification, a physical classification (=coordination) of the building blocks to be tested according to the result of the rating operation is taken. Therefore, in a preferred embodiment the classification is a conditional realization of a transport operation, coupled with a rating. According to the fulfillment or non-fulfillment of conditions, which have been derived from the result of the rating in form of a logic consequence, one or more directed transport functions is/are carried out. Therewith, chemical properties, which were identified in the test operation and were rated in the rating operation, are converted directly into a physical classification.

In principle, the number of possible classes, which can be formed with the at least one means for classification, is not limited. Preferably, the tested building blocks are mostly assigned physically to two classes, in other preferred embodiments however, the formation of three or more classes is also possible. In a preferred embodiment, it is possible, to classify the building blocks spatially addressable, so that after the event the test result at an individual building block can be assigned to an individual building block by means of its position, which is spatially addressable. Preferably, this classification, which is spatially addressable, is carried out in a manner, that the building blocks after at least one testing are put down in a definite format, for example a container or a micro titer plate. Thereby, in principle, the possibility exists that building blocks of the same class are put down in the same resp. equivalent array form, or that all building blocks are put down in one array form or in an array from, which is equivalent thereto, and later an exclusion of building blocks takes place, for example by means of a picker (pick-and-place, pincer), which can be assigned to a particular class (that means resorting out from the array).

The means for classification in the meaning of the present invention optionally comprises also a means for coding. With respect to more details of a possible coding of building blocks we refer at this point to the DE-A 101 17 274, the relevant content of which is fully incorporated by reference in the context of the present invention. Thereby, the classification is carried out by means of a coding of the building blocks of the material library. In said meaning, rating and classification are combined, what means that the means for the rating can be at the same time the means for coding. If the classification is carried out at the end of a test algorithm the put down of the building blocks to be tested within the designated classes is taken preferably in the means for storing, which can be applied as reservoirs for another test cycle, so that the building blocks can be smoothly processed in the further integrated high-throughput process.

Preferably, the at least one means for classification is realized by means of the use of other means according to the invention, as follows, whereby the hereafter denominated means can be coupled with another means for analysis and/or an means for recording and interpretation of data, respectively:
(i) by means of a means for supply a building block is changed physically, chemically or physically-chemically; so, for example, a fluorescent or a radioactive material can be fed to a building block and thus the building block can be changed physically, chemically or physically-chemically;
(ii) by means of a means for transport a building block is sorted into a means for storing or into another storage/receiver;
(iii) by means of a means for the recording and interpretation of data a correlation is produced between a property of a building block as well as of its (chemical) composition. So, for example, in a first test step a performance property can be tested and in a second step the composition of the building block can be identified by means of analysis. Said classifying information can be saved;
(iv) any combinations of (i) to (iii).

Conditioning: The device of the invention comprises optionally the possibility of the conditioning of at least one building block. Thereby, the conditioning operation comprises the treatment of a defined set or sub set of building blocks of a material library under defined conditions, which can be described by the parameter set P. The parameter set can comprise physical, chemical, the mechanical and/or biological parameters included temporal dependencies as well as arbitrary combinations thereof. If the building blocks are heterogeneous catalysts, for example said conditioning is carried out under reaction conditions in order to achieve a formation and/or aging and/or activation of the materials. Furthermore, treatment with heat, oxidations and/or reductions of the catalyst, aging with corrosive gases, regenerations is conceivable. Possible are conditions, too, which correspond to those ones of a treatment with steam, as well as hydrothermal conditions and/or treatments with electromagnetic radiation. It is preferred carrying out such a conditioning by means of at least one means for fluid supply.

The pretreatment or also conditioning can also comprise a one step or multi step calcination of the precursor of the catalysts in one or more defined atmosphere conditions. In principle, it is also possible to subject the building blocks to an electrical, electrochemical or optical treatment resp. excitation. Furthermore, any combinations of the above-mentioned parameters and conditions are possible.

Moreover, in a particular embodiment the conditioning is to subject an individual building block or a defined set or sub set of building blocks in a continuous manner according to the invention to one or more material transport processes or one or more material exchange processes. Thereby, material transport and material exchange processes with gaseous, liquid and solid media or mixtures of media are possible as well as chemical reactions with gaseous, liquid and solid media or mixtures of media.

In a preferred embodiment the conditioning is the application of at least one defined substance quantity onto individual or several building blocks. Thereby, for example, synthesis methods can be applied as described in the DE-A 100 59 222, in the DE-A 100 42 871 and in the DE-A 100 59 890. Such substances and/or mixtures of substances, which are applied onto the building blocks, can be reacted by exposure of chemical, physical and/or physical-chemical parameters, whereby a conditioning of the building blocks is achieved.

Preferably, the conditioning is carried out under steady state conditions with respect to the conditioning parameters in order that the building blocks of the library are in a steady state condition with respect to the temporal subsequent operation. In this case, for example, the conditioning is carried out in a manner that the building blocks of a catalyst library are continuously overflowed at a particular temperature and a defined pressure in their unit for uptake, that means typically in the reaction space, with reaction gas of a defined composition (for example 1% hydrocarbon in air) and a defined quantity.

However, also possible are temporal changes of the parameter set in the conditioning for the realization of a conditioning program. For example, this is reasonable in these cases, wherein the building blocks of a catalyst library have to be accessed before the test according to a particular, defined procedure, in order to achieve an optimal catalyst performance.

In a preferred embodiment the conditioning is carried out at a sub set consisting of as many building blocks as can be tested simultaneously according to the requirements of the device within the test operation. For example, if the device of the invention allows in the testing of building blocks the simultaneous testing of three building blocks, which are in their units for uptake, respectively, then it is reasonable conditioning another “three-way pack” of building blocks in an upstream step in their units for uptake, respectively, for example by overflowing with reaction gas. If the three building blocks to be tested are transported further after their testing, then the conditioned building blocks can take their place immediately, that means the process runs continuously.

Continuous: According to the context of the present invention the term “continuous” means that a permanent resp. constant movement of building blocks takes place inside of the device of the invention either towards each other or together or towards each other and together. The definition of said term can also include a short stop of the building blocks, preferably within a range of seconds, for the lead-through of operations. Possible process conditions can be: all building blocks are always in constant movement; all building blocks preferably between two or more steps resp. operations are in constant movement and are during the lead-through of one or several operations for a short time in stand still; combinations in such a manner that both building blocks are in constant movement during the lead-through of one or several operations, and, however, during one or several other operations a temporary stand still of the building blocks in the device, in which the operations are carried out, takes place. Thereby, the temporary stand still means that a building block remains for a preferably short period at a stationary geometrical defined position within a device or sub device, preferably exactly as long as the lead-through of a particular operation, for example the identification of a performance property of the building block, is terminated.

The device of the invention can also be denominated “continuous” in that meaning, that in defined temporal intervals at least one building block is inserted into the device or into a sub device through at least one input (inlet, supply) and/or is discharged from the device or a sub device through at least one output (outlet, discharge), whereby the defined temporal interval between the supply and/or discharge of a first sub set of building blocks and a second sub set of building blocks as well as between the second sub set of building blocks and a third sub set of building blocks can be the same or can be different from each other. Supply and discharge can be carried out by means of the same means for supply, for example an orifice.

In each case the device according to the invention allows the movement of at least one building block relative to at least one other building block in that meaning, that the position of the one building block relative to the other building block changes at least once during the integrated process of the testing. In the meaning of the present invention, said spatial movement also defines a continuous procedure of the process. Thereby, at least in principle the number of the building blocks to be tested is not limited by the design of the device.

Herewith, the device of the invention, as already pointed out in the discussion of the prior art, is fundamentally different from the known devices for the high-throughput testing of materials, because the number of the building blocks, which are applicable per testing, is in principle limited, for example by the amount of pipes in shell-and-tube reactors or by the number of recesses in a micro titer plate or by the size of the substrate in case of material libraries to be deposited on a substrate. Furthermore, the additional feeding and/or discharging of building blocks is/are not possible during the testing in the devices according to the state of the art.

Performance properties: Performance properties are measurable, preferably catalytic properties (as for example catalytic activity and/or selectivity), of the building blocks of the material library, which are registered with suitable sensors within, for example, automated testing (analysis). For example, the performance properties can be such ones of first or second order:

According to the context of the present invention, properties of first order are to the greatest possible extend such property characteristics, which can be obtained by means of physical characterization methods, as for example X-ray diffraction, LEED-structure determination, EDX, X-ray fluorescence analysis; X-ray photoelectron spectroscopy, Auger-spectroscopy. Examples for properties of first order are: inter-atomic distance, element composition, etc.

Properties of second order are those property characteristics, which are accessible by means of physical-chemical characterization methods, as for example nitrogen adsorption (surface dimensions (BET)); TPD (bond strengths of absorbates on surfaces or selective chemisorption—size of the surfaces of active centers).

Substrate-less: As explained above in the state of the art, building blocks have to be positioned at stationary positions (substrates, arrays) when using the known devices. In contrast, according to the invention, the building blocks are directed substrate-less through the process, whereby substrate-less means that the building blocks are not tied to a certain place. That means that during the lead-through of the process the building blocks can change their geometric position according to the invention continuously relative to or within the device of the invention and/or preferably also a geometric independence of the building blocks exists among themselves.

Cycle: In principle, the non-stationary component of the device of the invention can be moved continuously in a constant manner that means in a permanent rate without stopping. However, in a preferred embodiment the non-stationary component is moved ahead cycled, that means in particular intervals, wherein the component moves with a steady rate, as well as in other particular intervals, wherein the component rests. Generally, no restrictions exist with respect to the duration and the sequence of said intervals.

Testing: The testing in the meaning of the present invention comprises at least: (i) the lead-through of a reaction resp. the exposition of the at least two building blocks to be tested for test conditions (reaction conditions), or (ii) the direct or indirect analysis of the reaction of the one building block or the building blocks concerning said exposition or (iii) both. Thereby, the exposition can be related to a substance, for example a fluid, which can activate a reaction, or to type of radiation, in particular of electromagnetic nature, as it occurs during an analysis.

In the testing, the building block to be tested is tested under defined conditions, which can be described by means of a parameter set P, which can be the same or can be different for different building blocks. The parameter set can comprise physical, chemical, mechanical and/or biological parameters included temporal dependencies as well as any combinations thereof. If a test for catalytic properties of a building block is carried out, then, for example, the building block is contacted in a defined manner with fluid reactants at a particular temperature resp. a particular pressure and with particular flow conditions.

In a preferred embodiment of the present invention, the building block to be tested is during the testing in a defined position inside of the device for the lead-through of the test operation. For example, a building block is positioned at a defined position inside of the device, preferably a micro reaction space, and is contacted in said position with fluids.

In doing so, in a preferred embodiment thus the reaction space can result in positioning the building block in its unit for the uptake within the device in such a manner, that it is in contact with another constituent part of the device, for example a means for supply, which is integrated in the stationary component of the device. Preferably, the reaction space is formed as composition of different cavities and/or parts of the device of the invention. Thereby, the geometry of the reaction space can change or can remain constant during the steps resp. operations.

As example for the determination of a performance property, the fluids resp. reaction products, which discharge from the reaction space, are checked for by an analysis, whether the building block has a particular catalytic property, for example the property to oxidize a hydrocarbon partially in presence of air or oxygen.

Thereby, within the reaction space of the invention, preferably non-dimensional identification numbers are obtained, as they are relevant in embodiments, which are by means of their reaction technique close to industry (Levenspiel, Octave: Chemical Reaction Engineering, Third Edition, 1999, John Wiley & Sons, Inc., p. 660 and 661, DE-A 101 17 275). Thereby, the reaction space is preferably formed in a manner that only very small or no clearance volumes occur. A geometric design of the reaction space, which is free from clearance volumes or is poor with clearance volumes, has the advantage that thereby very short response periods can be achieved within the test of a new building block. Furthermore, longer rinsing periods can be avoided, and zones with undesired condensate deposits or abrasion deposits can be reduced.

In a preferred embodiment, directly after the test of a building block the building block to be tested is taken over by means of a means of transport and transferred to the next operation, which is designated by the means for automation. At the same time, the next building block reaches the testing by means of another transport operation. Hereupon, said next building block is immediately subjected to the next testing, preferably for a performance property. Hereby, in a preferred embodiment, the test can start immediately, because by means of the previous conditioning operation the building block is already in a stationary condition.

Thereby, in another preferred embodiment, the building block is in defined, stationary conditions. Thereby, an analysis of performance properties of the building block is carried out, which can take place according to methods known to the one skilled in the art. Preferably, methods are applied, with which an analysis of performance properties can be carried out within a period of less than 10 min, more preferred of less than 1 min, still more preferred of less than 10 s and still more preferred of less than 1 s per building block. According to the arrangement of the test operation within the test algorithm, it can be defined which performance property should be tested and which density of information should be achieved thereby.

According to the density of information, the methods for analysis of performance properties can be classified in “Boolean methods” and methods with greater density of information. For example, Boolean methods provide a yes/no information about the performance of a building block with respect to a performance property, for example the activity of the building block as catalyst in a heterogeneous catalyzed reaction. Another possible Boolean information is the presence of a particular product molecule. For example, such informations can be determined with techniques for analysis like photo acoustic spectroscopy, IR-transmission, IR-emission, thermal deflection spectroscopy, Raman-spectroscopy or optical indicator detection. In this connection in particular the relevant disclosure of the DE-B 198 30 607 is fully incorporated by reference in the present invention.

In a preferred embodiment, Boolean analysis methods can be combined, in order to gain better information with respect of the checked performance properties. Exemplified is the combination of photo acoustic spectroscopy and IR-thermography. For example, by means of infrared thermography, the activity of a building block can be proved, for example by means of photo acoustic spectroscopy a measure for the amount of the produced CO₂ can be indicated subsequently. Derived out of it, appropriate classifications can be taken by means of particular rating rules within the rating operation. For example, superior information densities as well as gradations in the activity or selectivity can be obtained by means of methods like MS, GC, GC-MS and multi-dimensional infrared sensitometry.

Transport, means for: In order to enable a testing of building blocks within the device of the invention, transport operations typically are necessary, which are arranged by a means for transport. A means for transport is for the movement of a building block between two spatially different positions inside of the device. Thereby, the movement can take place in any direction as well as can be composed of an arbitrary sum of sub movements. Preferred sub movements are translation and rotation. In the actual case of rotation of a non-stationary component in relation to a stationary component, for example a sequence of movements can be as follows: detaching of the stationary component from the non-stationary component, for example by means of the reduction of the pneumatic contact pressure or by means of a translation movement; turning (rotation) of the non-stationary component; pressing of the stationary component at the non-stationary component by translation, for example arranged by a pneumatic mechanism.

The transport of individual building blocks of the material library, of a sub set or the complete set of the building blocks of the material library is thereby possible. Thereby, in principle the transport of the building blocks can be carried out with the methods known to the one skilled in the art, for example by means of a mechanical or physical manner. Preferably, pneumatic transport methods (applying overpressure or low pressure), mechanical moved elements, transport fluids, optical forceps, force fields in general, sound fields, electrostatic methods, magnetic methods, piezo-elements, gravitation and the like, as well as combinations of the before-mentioned methods. It is preferred to use out from the mechanic methods wheels, combs, conveyor belts, screws, “revolving doors” (for example impellers), pickers (for example pick-and-place devices), forceps, pincers, metering devices, lorries, tubes, and the like, and/or combinations thereof.

In the meaning of the present invention also such constituent parts of the device of the invention are means for transport, which only arrange indirectly the transport, or which interacts with other constituent parts of the invention for the purpose of the movement of a building block. So, for example, a means for drive can be a means for transport, like an engine or a spring device. Quasi a means for force transmission can be a means for transport, like a gear, a belt or a mandrill. Preferably, a means for transport is characterized in that it (or parts of it) as well as the non-stationary component move relatively to a stationary center of reference outside of the device in the space.

Preferably, the building blocks to be transported are on the complete transport way in a defined, preferably steady state condition, further preferred steady state condition with respect to reaction technique. Thereby, this preferably can be ensured by the flowing through, the flowing around and/or flowing against of the entire transport way in a defined manner, with fluids for conditioning and/or reaction, also sequentially, by being under a defined pressure and by tempering in a defined manner, also sequentially. By means of said means it is ensured, when entering the next sub device (for example the next part of the device), that the building blocks are already in the desired condition therein, respectively. Thereby, for example an instantaneous testing of the building blocks in the test operation is possible, and a steady state test condition of the building block is achieved without loss of time.

As a rule, for the acceleration of the operation low clearance volumes are advantageous. Besides the transport function a further process mode can optionally be realized, which enables the rinsing and cleaning of the module to be used from unwanted residues (abrasion, condensates, remaining gas quantity, etc.). The transport way can be formed geometrically in a manner that undesired residues like abrasion and condensates accumulate at defined positions within the transport system and can be collected and discharged in a defined manner.

Supply, means for: The at least one means for supply, which is a constituent part of the device of the invention, in principle has the function feeding any substance and/or any type of radiation, which could be relevant for the testing, to the unit for the uptake of one building block. To the substances to be fed belong in particular (i) fluids, in particular those for conditioning, rinsing and/or testing and (ii) the building blocks. For example, the fluids are reaction gases/liquids, conditioning gases/liquids or gases for drying resp. heating, etc. In particular, the radiation to be fed is the radiation, which is relevant within the scope of the analysis method to be used, respectively. Thereby, in particular the radiation is electromagnetic radiation, preferably IR-radiation, visible radiation and X-ray radiation. Magnetic fields are also preferred.

A means for supply can be at the same time a means for discharge of the denominated substances resp. radiation. In the meaning of the present invention any lots of supply (feed, inlet) can exist, wherein any sub set thereof can be for the discharge (outlet). The direction of the supply resp. discharge can invert arbitrarily often and at any time in the same means for supply.

It is further preferred that the means for supply consist of ducts with a cross sectional area in the form of a polyhedron or a circle, whereby the cross sectional area can change along the lengths of a duct, for example, can be tapered, or can be leveled off. Concerning the design of such ducts reference is made to application DE-A 101 17 275, whose relevant disclosure is to be fully incorporated. It is preferred that the means for supply are composed, for example of duct and membrane or duct or sealable cover or duct with restriction.

The means for supply can also act as (passive) pressure control elements, in particular as pressure reducer, resp. in case of a plurality of units for the uptake of a building block to be linked together, also as pressure (equi)distributor. According to said meaning the ducts can be formed in their lengths, their characteristics and/or in their diameter in a manner that the desired pressure adjustment is achieved resp. optimized, respectively. So, for example, it is possible and it is indeed preferred in the meaning of the present invention realizing the ducts with a characteristic, which is formed like a meander.

At least the stationary component of the device of the invention must possess a means for supply. The non-stationary component can possess a means for supply, but need not possess a means for supply. For example, the non-stationary component can be formed in a manner, that the unit for the uptake of a building block, which is embedded therein, possesses an open side, which meets by moving the component relative to the stationary component the means for supply, which is located inside of said component, for example the polished end of a duct, which is embedded within a full material, and flushes with said means in a way that the full material inclusive the orifice of the duct seals the unit for uptake and establishes at the same time an access to the unit.

In a preferred embodiment, at least one of the following elements: restrictor, membrane, connecting piece, sealing unit are (i) in the unit for uptake or (ii) in a means for supply or (iii) in a reaction space or in any combination of (i) to (iii).

Further details of the invention are exemplified in the drawings at hand of the following figures. The details, which are partly given in the figures, thereby, must not be understood in a way that thereby the general validity of the aforesaid disclosed embodiments would be restricted somehow or other. In particular, the figures are partly (schematically) simplified, several components are often presented as one component for clarity, tools like heating, thermal elements, feed-lines, filters, seals, etc. were often omitted, the means for supply are illustrated simplified in the schematic views, etc. Hereby, the figures show in detail:

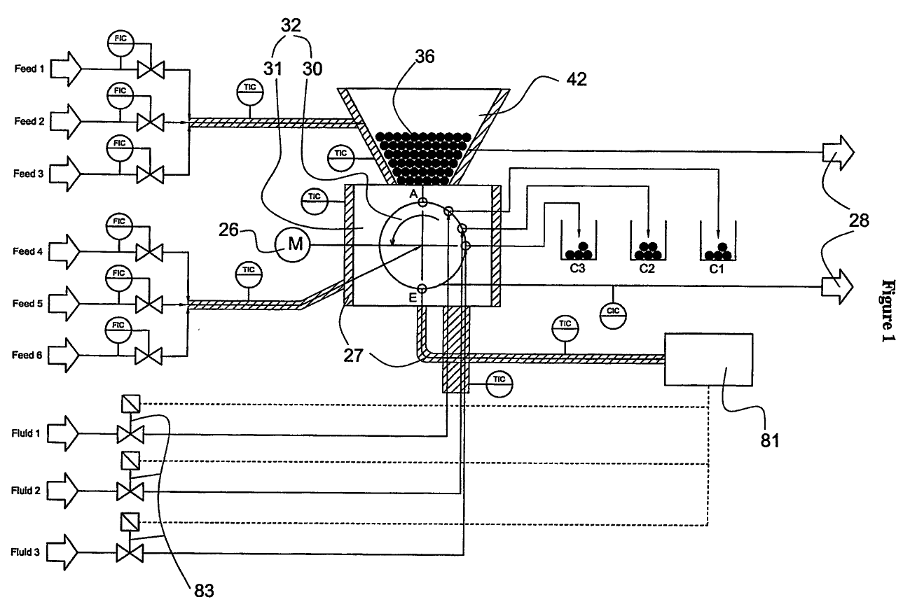

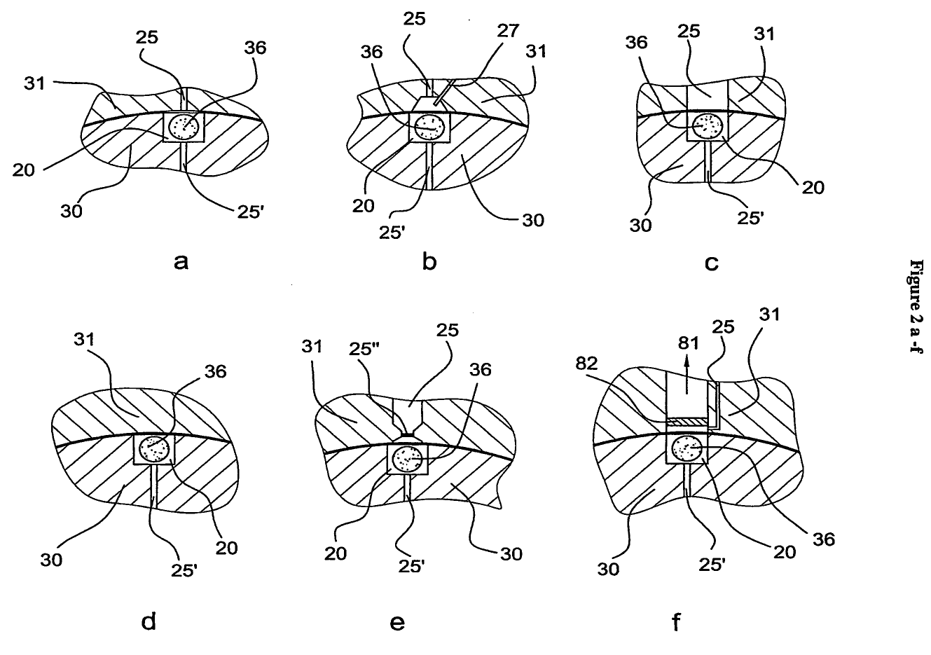

FIG. 1: schematic illustration of the device of the invention with rotational single bead reactor;

FIG. 2: (a) to (g): concept drawings for the clarification of the geometry of the reaction space around a building block in the device of the invention;

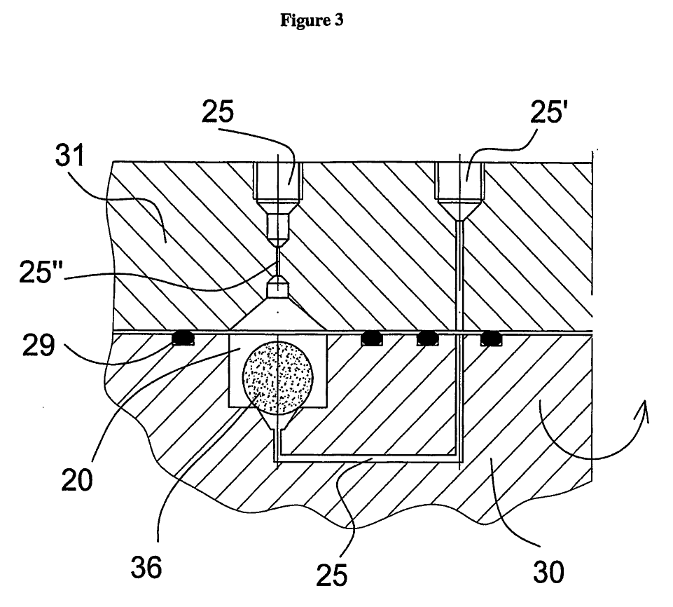

FIG. 3: concept drawing of the reaction space with means for supply and means for fluidic sealing;

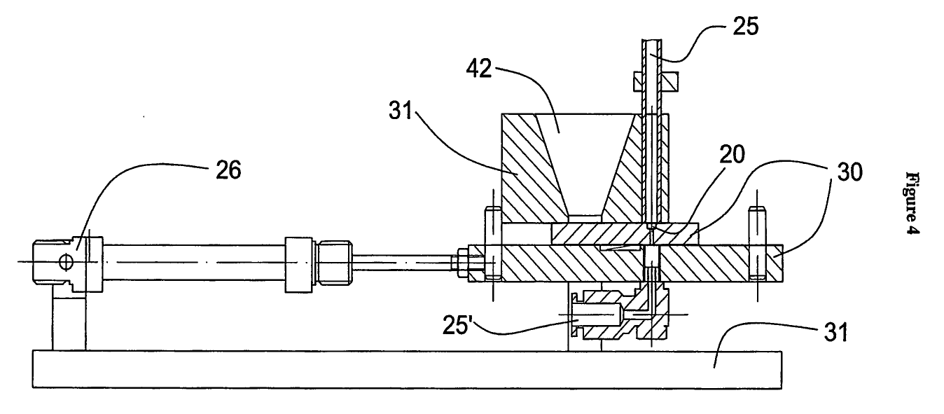

FIG. 4: schematic illustration of a sub device for selection of a building block from a set of at least two building blocks;

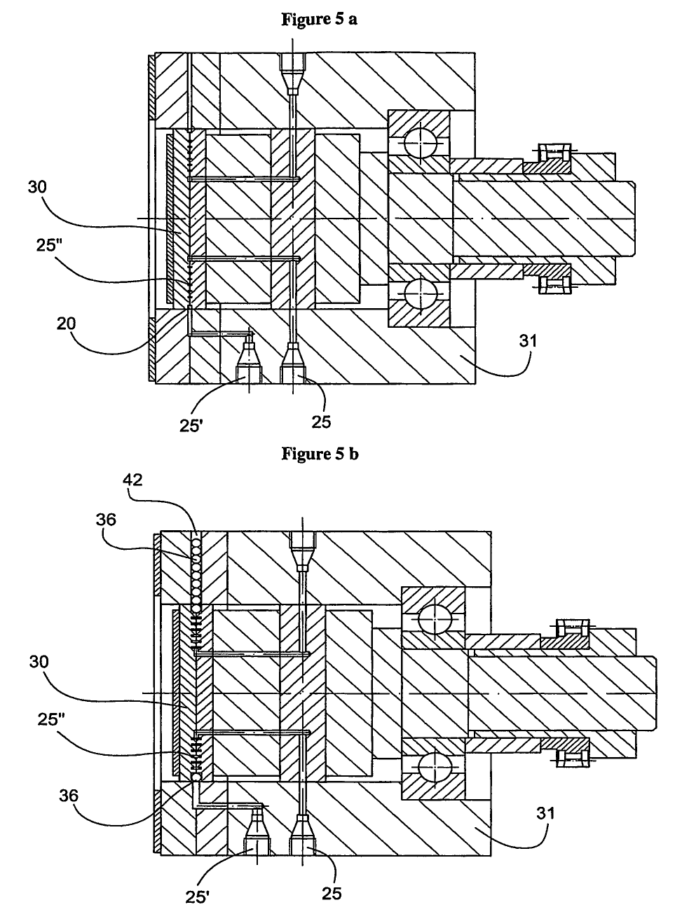

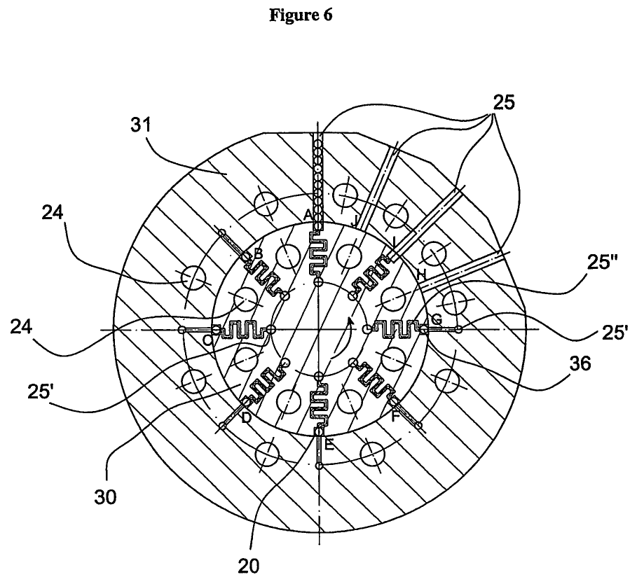

FIG. 5: (a): total view of an embodiment of the device of the invention with righted rotatable body (non-stationary component) as well as the stationary component involved therewith (lateral view); (b): another embodiment;

FIG. 6: detail view (section) of the embodiment from FIG. 5;

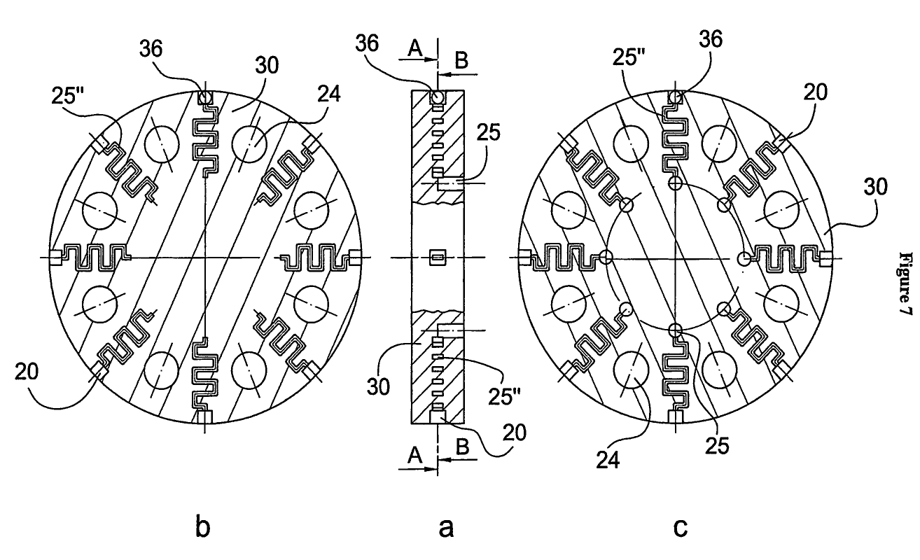

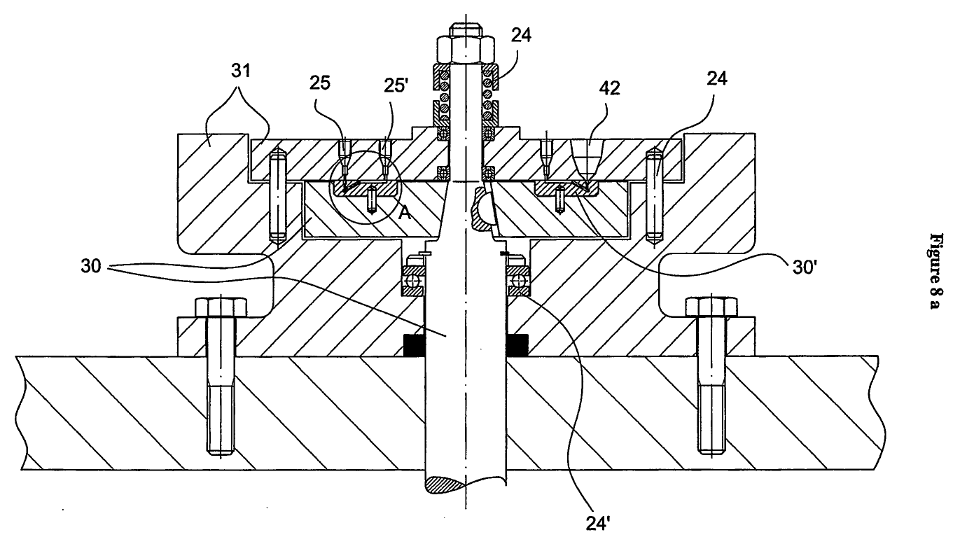

FIG. 7: detail view [7(a): radial local section, 7(b), (c): section) of the non-stationary component from FIG. 5 (here a rotating, righted disc with recesses as units for uptake);

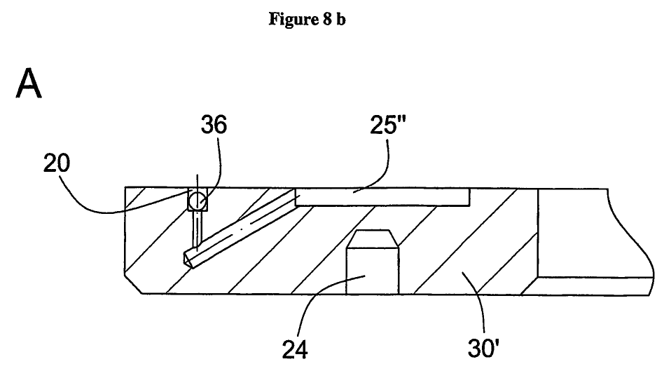

FIG. 8: (a) total view of an embodiment of the device of the invention with horizontal rotatable body (non-stationary component) as well as the stationary component involved therewith (lateral view); (b) detail of the unit for the uptake of a building block (vertical overflowing of the building block);

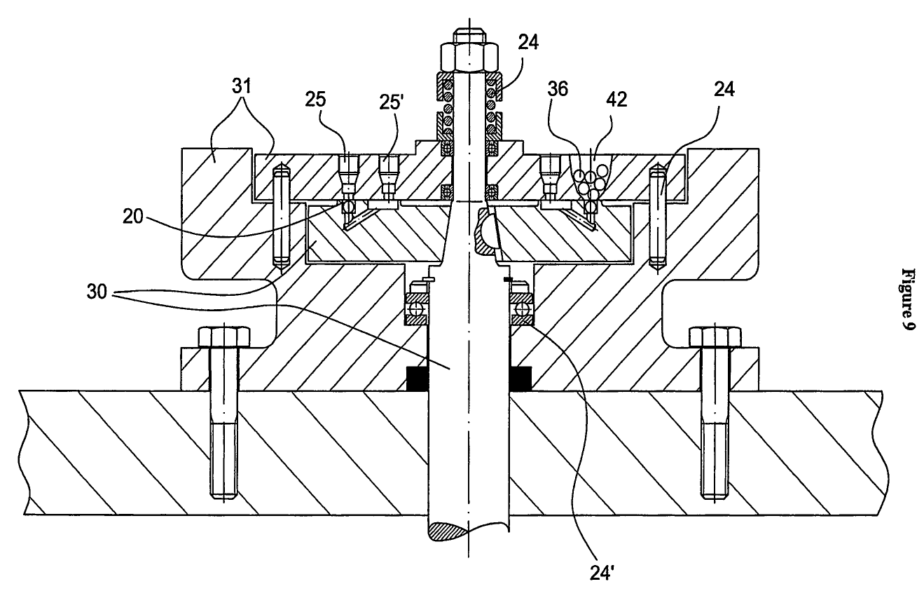

FIG. 9: another total view of an embodiment of the device of the invention with horizontal rotatable body (non-stationary component) as well as the stationary component involved therewith (lateral view);

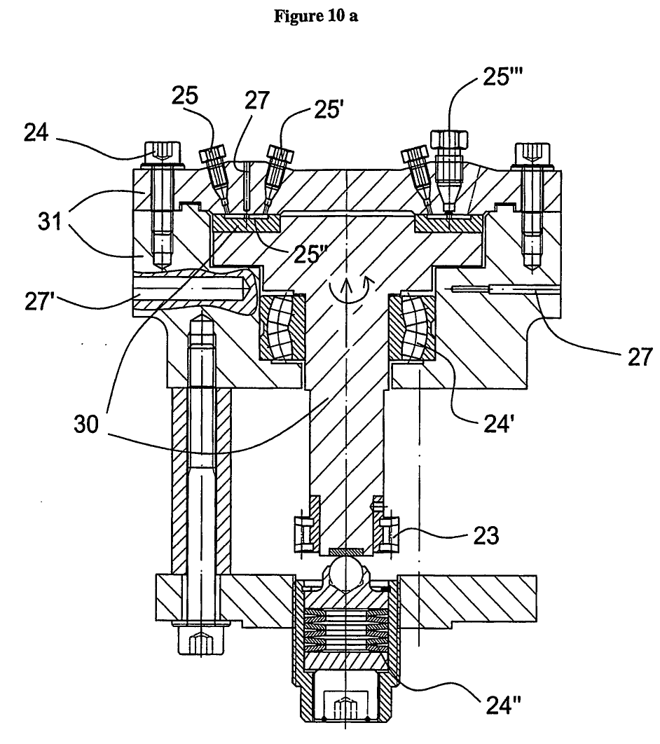

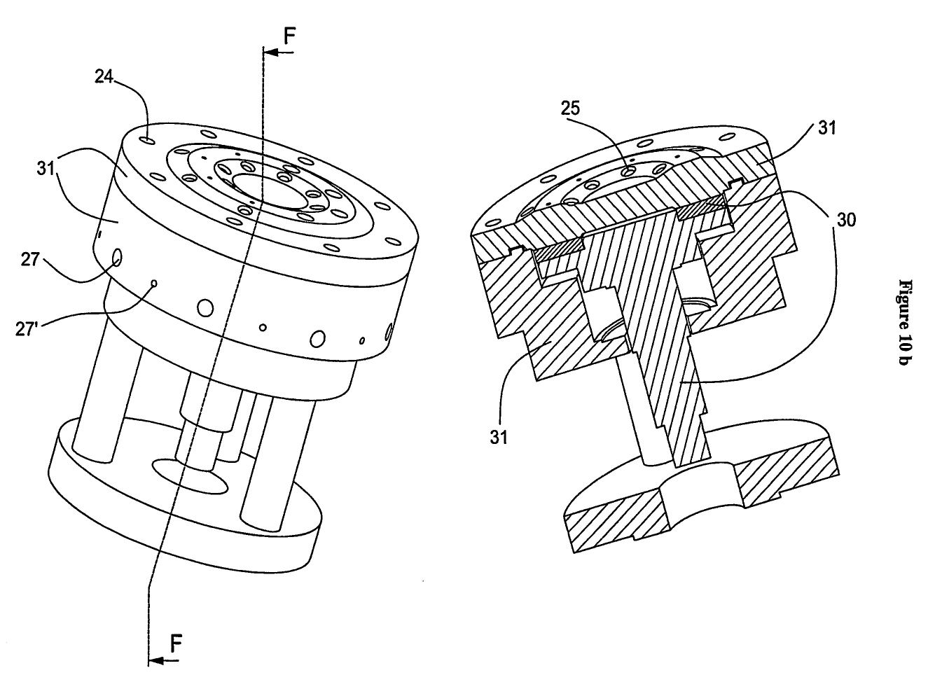

FIG. 10: (a) total view of another embodiment of the device of the invention with horizontal rotatable body (non-stationary component) as well as the stationary component involved therewith (lateral view) with modified units for the uptake of the building blocks as well as means for supply (lateral view); (b) three dimensional illustration of the embodiment from FIG. 10a with additional section illustration; (c) three dimensional illustration of the embodiment from FIG. 10a in exploded view;

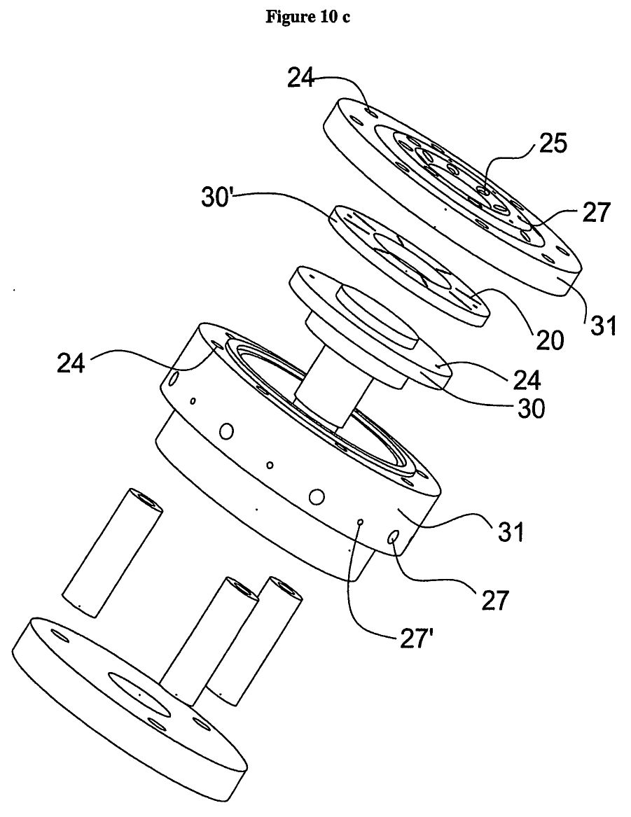

FIG. 11: detailed illustration (top view) of the upper, stationary component from FIG. 10 (here: horizontal disc with means for supply as well as means for mounting and for means for control of parameters P like thermal elements or heating candle);

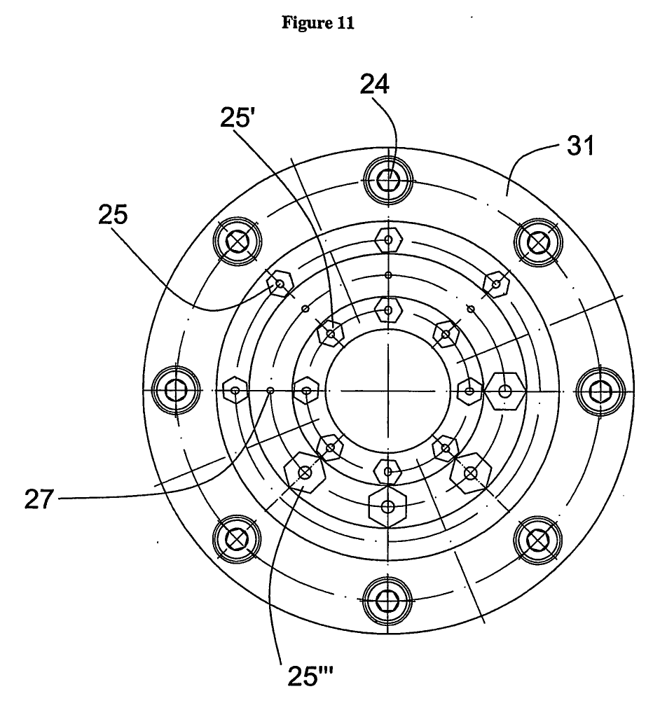

FIG. 12: detailed illustration of a part of the non-stationary component from FIG. 10: (a) top view of the unit to be overflowed horizontally for the uptake of a building block with means for supply; (b) exemplary arrangement of 8 units for the uptake of building blocks on a rotatable body (top view); (c) detailed illustration (top view) of another embodiment of a horizontal rotatable body with means for supply and a specific embodiment of the unit for uptake (connection piece) (d) detailed illustration of the specific embodiment shown in FIG. 12c of the unit for the uptake (connection piece) and means for supply;

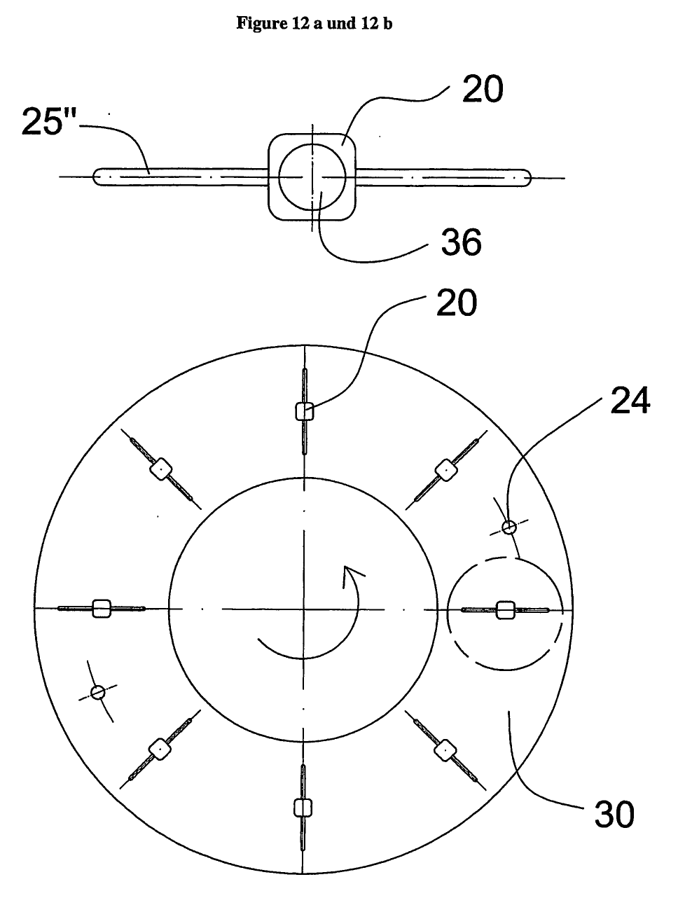

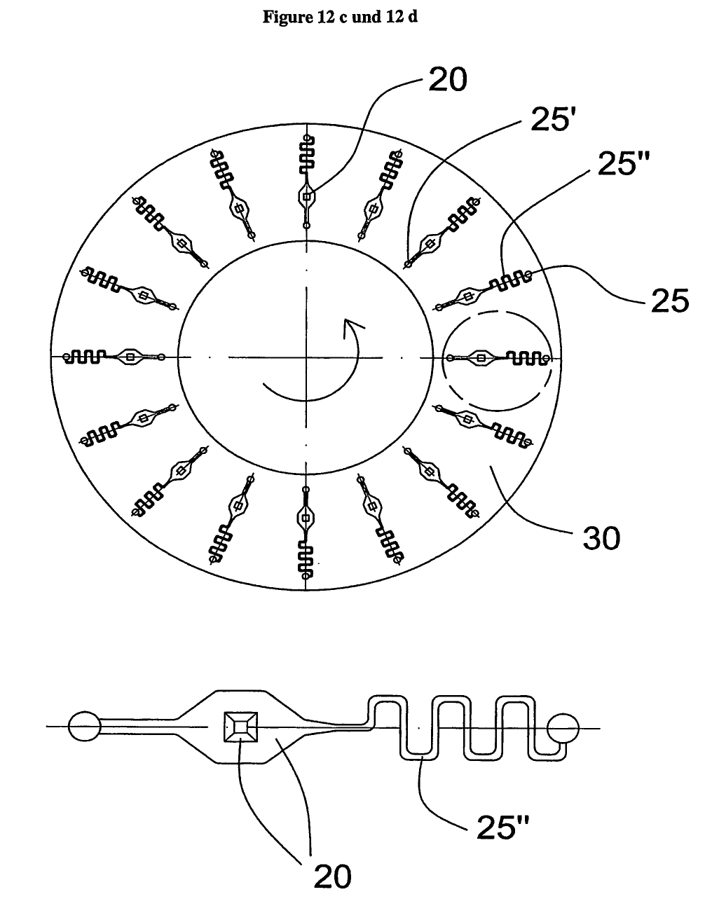

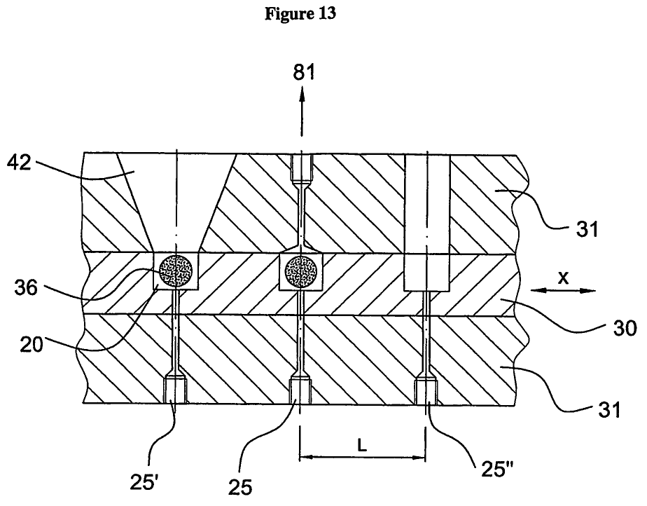

FIG. 13: schematic illustration of the device of the invention, in which the non-stationary component is a linearly shiftable bar (lateral view);

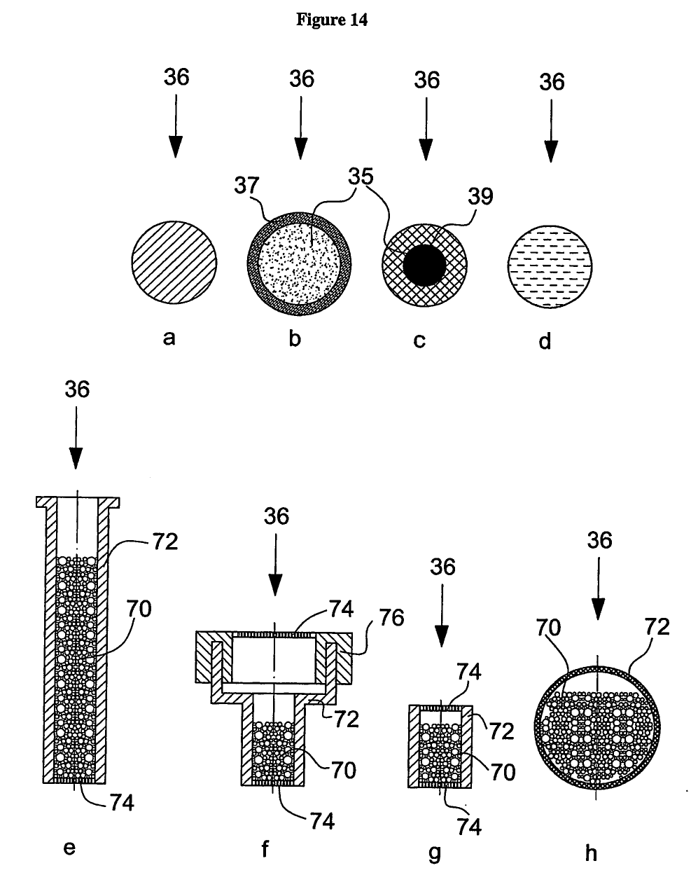

FIG. 14: (a) to (h): schematic illustration of possible embodiments of the building blocks;

FIG. 15: (a) schematic illustration of the arrangement of a reservoir, which is charged, as building block within a reaction space; (b) schematic illustration of the supply of reservoirs, which are charged, as building blocks within a unit for uptake; (c) schematic illustration of another embodiment for the uptake of a reservoir as building block within a reaction space (here composed of unit for the uptake of the non-stationary component as well as means for supply of the stationary component);

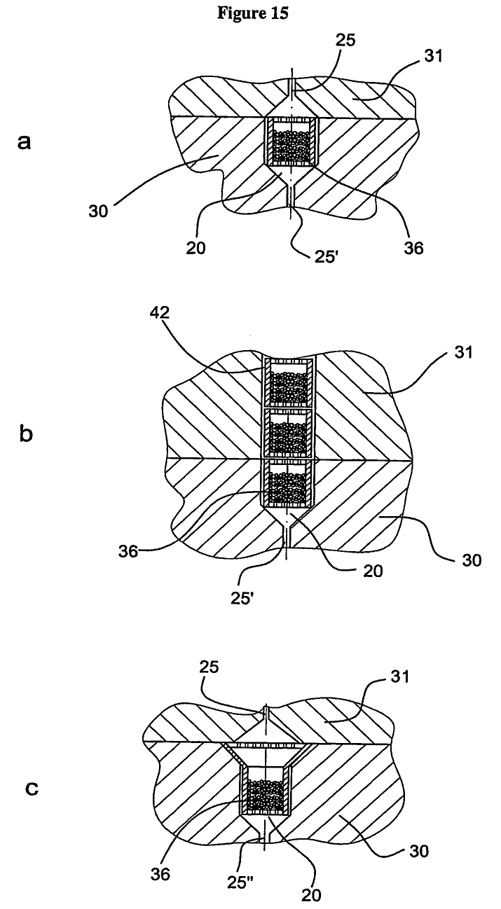

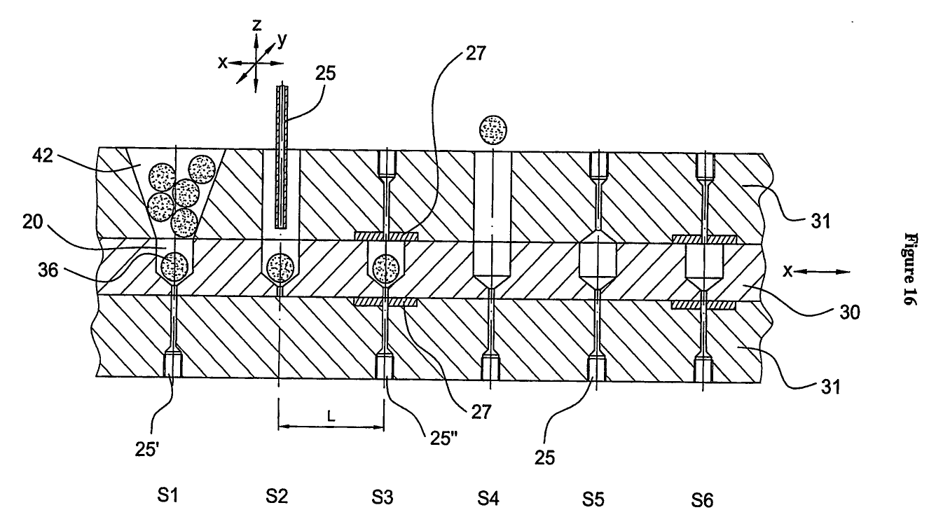

FIG. 16: schematic illustration of a device of the invention arranged as shiftable bar for the manufacture and/or conditioning of building blocks (lateral view);

FIG. 17: schematic illustration of a specific embodiment arranged as shiftable bar for the testing of liquid batches.

FIG. 1 schematically shows an embodiment of the device of the invention in the “rotational single bead reactor”-configuration (32), consisting of the components 30 and 31. Thereby, the building blocks 36 of a material library are stored within a means for storing 42 and are already overflowed, that means conditioned, for example from bottom-up with a mixture of fluids (defined composition of feed 1, feed 2 and feed 3) in a defined manner within said means for storing. Thereby, the means for storing 42 as well as the fluid feed-line are tempered in a defined manner. The high-throughput test of the invention takes place in a rotational single bead reactor 32, which is located below the means for storing 42.

A circular rotatable body is realized as non-stationary component 30 of the device in the meaning of the invention; and in fact here as disc. The non-stationary component 30 is connected via a bearing (not shown here) with the stationary component 31. By rotating the non-stationary component 30 of the reactor 32, within each cycle exactly one building block 36 arrives at the therefore determined unit for uptake (position A) of the rotatable body (the unit for uptake is not shown in this figure, however, see FIG. 2 and following Figures). The exact embodiment of the rotatable body as well as the units for uptake is discussed in more detail at hand of the following Figures.

By cycled rotation of the rotatable body 30 by means of a means for drive 26 (here an engine M) the building blocks 36 arrive one after another at positions, in which another conditioning operation can be carried out, this time with a mixture of fluids, which is composed of feed 4, feed 5 and feed 6. In another position E of the rotatable body 30 (in the drawing indicated at the lower end of the rotatable body) afterwards the testing is carried out, whereby the building block 36 to be tested is overflowed with the same mixture of fluids as in the preceding conditioning. The fluid to be flowed off from building block 36 at the test position is directed completely or partially to a means for analysis 81, which effects an analysis for performance properties, for example the identification of the catalytic activity and/or catalytic selectivity.

In order to adjust a suitable set of parameters P for the testing, the reactor 32 can be tempered for example by means of means for adjusting the set of parameters 27, here a heater. Furthermore, the adjustment of a desired pressure is possible (not shown in FIG. 1). The values to be measured for a building block, which are identified by means of the means for analysis 81, are forwarded electronically to a means for control and/or operation, typically to a computer (in FIG. 1 also not shown). In said means by means of suitable means for computer programs preferably a rating of the measured values in comparison to one or several threshold limit values is carried out. From this, typically as consequence results, which of the three classes C1, C2 or C3 the building block 36 should be assigned to.

The above-mentioned classification. is preferably implemented pneumatically by means of the fluids 1, 2 and 3. For example, if the building block 36 has to be assigned to the class 3, then by means of the switching mechanism of a magnetic valve 83 a pressure shock with fluid 3 (pressure impulse) is exerted to the corresponding unit for the uptake of the rotatable body, as soon as the building block 36 according to the cycled twist of the rotatable body 30 is in the appropriate position. Said process is preferably carried out and operated/controlled electronically. The assignment of building block 36 to class 2 is carried out analogously, whereby the pneumatic pressure shock with fluid 2 is exerted, in turn switched by a magnetic valve 83. Then, all remaining building blocks 36 are discharged by means of fluid 1 and are assigned to class 1. The feed-lines of the fluids for the classification may also be tempered, in order to avoid an undesired thermal over-ride of the reactor 32 by means of the fluids. The discharge stream of the unneeded fluids takes place in a controlled manner by means of the discharge stream 28.

FIG. 2 shows schematically, how a building block 36 arranges itself within a unit for the uptake 20, whereby in this case the unit for uptake is a constituent part of the non-stationary component 30. Thereby, the reaction space is formed in interaction with a part of the stationary component 31.

FIG. 2a shows a simple unit for the uptake of a building block, inside of which is a building block 36. The unit for uptake 20 is formed by a cavity, which is within the non-stationary component 30, and which, for example, can have a cylindrical or quadratic geometry. Additionally, the unit for uptake is connected with a means for supply 25 in the stationary component and with a means for supply 25′ in the non-stationary component. Thereby, the components are formed in a way that the cavity is sealed in the non-stationary component by the stationary component, whereby, however, the access to the cavity is retained by means of the one means for supply (respectively the means for supply). Overall, a reaction space is formed by means of said unit. The building block to be treated is therewith embedded in said position within the cavity, however, for example, can be overflowed with fluids by the illustrated means for supply 25 and/or 25′.

FIG. 2b exemplifies the geometry of the reaction space, which is formed, when the non-stationary component 30 is moved and, therewith, the building block 36 is transported to another position. In difference to FIG. 2a, at said new position the local geometry of the reaction space is formed differently. Here, the stationary component 31 has a cavity as well as the non-stationary component with its unit for uptake, so that a larger reaction space than in FIG. 2a is formed. Therewith, for example, a more homogeneous, more favorable overflowing with respect to reaction technique of the building block 36 is achieved. The form of the covered geometry, which surrounds the building block, has therewith changed by means of the discussed movement of the non-stationary component, in order to allow a different treatment of the building block. Additionally, it is possible, that the nearer surrounding of the building block resp. the cavity, has means for the operation and measurement of parameters, so, for example, a means for tempering and appropriate means for the measurement of temperature, for example a thermal element 27, which extends into the reaction space.

In FIG. 2c, the geometry of the reaction space is illustrated, which is formed around the building block after another movement of the non-stationary component. Herein, the stationary component 31 now has a means for supply 25, which is clearly enlarged in the cross sectional area, which optionally allows discharging said building block from said cavity or optionally also allows the feeding of said building block, which is in the cavity of the non-stationary component.

In FIG. 2d is an embodiment exemplified, whereby the building block 36 is in a cavity, which is sealed towards the stationary component. For example, said situation could occur during the time period, during which the building block is moved in its unit for uptake 20 in the non-stationary component 30 relatively to the stationary component 31.

In FIG. 2e an embodiment is exemplified, in which the means for supply are characterized in the stationary part as pore membrane 25″ with straight, continuous pores. Thereby, for example, said membrane acts as restrictor for the regulation of the fluid flow through the pores of the membrane. Furthermore, by means of the membrane an undesired feed of solid particles into the cavity can be avoided.

Finally, in FIG. 2f an embodiment is exemplified, in which between the stationary and the non-stationary component a cavity is formed, which is fitted with two means for supply, whereby a continuous overflowing of the building block with, for example, reaction gas is achieved. Additionally, in said particular embodiment, the cavity has an IR-transparent window, through which for example by means of an IR-camera, that means a means for analysis 81, the reaction of the building block with respect to the exposition to reaction gases can be monitored on-line.

Finally, in FIG. 2g a simplified geometry of the non-stationary and the stationary component for the realization of the geometries, which are described in FIGS. 2a-2f, is illustrated, without that said arrangement would have to be realized in fact in said form and arrangement. The view is only for the illustration of the term “changeable geometry” as it is used within the context of the present invention.

The examples as illustrated in FIGS. 2a-2f reveal that by a relative movement between the non-stationary and the stationary component of the device of the invention appropriate adjusted geometries and therewith functions of the local forming of the space around a building block can be realized.

FIG. 3 shows a reaction space, which is characterized between the stationary component 31 and non-stationary component 30, which is existent in a particular embodiment. Thereby, the building block 36 seats punctually on a connecting piece of the unit for uptake 20, for example a connecting piece, which is formed as a pyramid, so that a flowing off of the fluid from top to bottom cannot be constrained by blockage of the means for supply by the building block. Furthermore, thereby the building block is fixed centrally within the reaction space and an all-side steady-going flow around said building block is achieved.

Furthermore, the stationary component has within the region of the means for supply 25 a narrowing of the supply duct 25″ (restriction). Said restriction of the flow cross section on a particular flow length results in case of the flow-through of the duct with fluids in a pressure loss, which is clearly higher than the pressure loss within the other flow path. By means of said specifically adjusted pressure loss, an equipartition between different reaction spaces can be achieved during the simultaneous incoming flow. Preferably, said narrowing of the supply duct is upstream of the building block, that means that the means for supply, which serves as feed-line, is the 25′ in said configuration. Moreover, concerning the flow conditions, it has to be marked that the device is preferably formed and run in a manner that the pressure loss between the stationary and the non-stationary component in case of a potential flow-through of the gap, is so high, that the bigger part of the fluid finds the way through the means for supply of the invention.

Furthermore, between the stationary and the non-stationary component is a means for fluidic sealing 29, what is in said case an O-ring. This has the target avoiding or strongly reducing a cross-stream of fluids in the gap, which may occur between the stationary and non-stationary component. It is known to the one skilled in the art that thereby means for sealing can be applied, which, accordingly, are thermally and mechanically stabile, and which are to the greatest possible extend abrasion-resistant. For the insertion of the means for sealing, cavities or ducts can be positioned in the stationary and the non-stationary component, which, for example, run radially or also concentrically, etc., around an area to be sealed.

FIG. 4 shows an embodiment for a means for selection of at least one building block out from a set of at least two building blocks. The building blocks, which have to be selected from, are in the means for storing 42, here in a tapered receiver. Said means for storing has an outflow (not shown here), by means of which building blocks can fall into a suitable means for uptake. In the position of the movable bar 30, which is shown in FIG. 4, the outflow from the means for storing is sealed by the bar and a discharge of building blocks from the means for storing is made impossible. The bar can be moved along an axis by means of a means for drive 26 in a manner that the unit for uptake 20, which is on the bar 30, is aligned with the outflow of the means for storing, so that a building block, resp. dependent on the size of the unit for uptake 20 also several building blocks, respectively, falls resp. can fall into the unit for uptake. The means for drive can be an engine, which moves the bar forwards or backwards, or, however, for example can be a pneumatic drive, as it is the case here.

After the uptake of the building block (resp. the building blocks), the bar 30 is run by means of the means of drive 26 to a position, in which the unit for uptake 20 is aligned with a means for supply 25, here a capillary, which is at least so big allowing the uptake of a building block, as well as with another means for supply 25′, which is for the supply of compressed air. Said configuration is shown in FIG. 4. By applying a pressure difference (here: applying a pressure shock) by means of the supply 25′, now the building block from the unit for the uptake 20 can be transferred into the capillary 25, and can be inserted for the continuous testing by means of said capillary into the unit for uptake of the real device. By means of a sensor in or at the capillary, for example a light barier, can be detected, whether by the repeated movement of the bar 30 in fact a building block (or optionally several building blocks) was (or were) selected.

FIG. 5: FIG. 5a shows the total view of an embodiment of the device of the invention with a righted rotatable body 30, which represents the non-stationary component in the meaning of the present invention, and which is realized as disc in the case at hand. Said rotatable disc 30 is integrated within the stationary component 31, which encircles the rotatable disc in a way, that the means for supply 25 and 25′ of the stationary component 31 are aligned with the corresponding means for supply resp. the units for uptake (here: orifices) of the rotatable disc 30, respectively. So, for example, in the present configuration, the means for supply 25 is for the supply of conditioning gas or test gas. Thereby, the means for supply 25 of the stationary component is aligned with a means for supply 25″ of the rotatable disc. The means for supply 25″ is a duct, which is positioned in the plane of the disc, which is formed in the manner of a meander (compare for this the section in the plane of the rotatable disc from FIG. 6). This characterization of the duct in form of meander is for the creating of a way for the gas, which is as long as possible, that means to generate a pressure loss for the equipartition of the fluid, which is defined as precise as possible.

At the end of the means for supply 25″ of the rotatable disc 30 is a unit for uptake 20, which contains the building block (building block is not shown here). For example, in a preceding operation, said building block can have been fed by means of the means for the selection into the unit for uptake, which is shown in FIG. 3. Said unit for uptake 20, which is at the end of the means for supply 25″, is in turn on its part aligned with the means for supply 25′ of the stationary component 31, so that the gas, which flows around the building block, can be discharged by means of the means for the supply 25′. After the operation, which has been carried out with the unit for uptake 20 in said position of the rotatable disc 30, the rotatable disc can be forwarded with the building block within the unit for uptake 20, for example in a manner that the unit for uptake is in the contiguous position (see hereon also FIG. 6).

FIG. 5b shows another modified embodiment, whereby a duct is formed as means for storing 42, which stores the building blocks 36. Said building blocks fall along the preferred direction of the gravitation into a unit for the uptake of the rotatable disc, what may be supported by applying a pressure difference connected with a fluid flow (see FIG. 5a).

FIG. 6 shows a detailed view (section along the middle axis of the rotatable disc) of the embodiment from FIG. 5. Thereby, the stationary component 31 has a plurality of means for supply 25, whereby a means for supply, as shown in FIG. 5b, is a means for storing. The exact number of means for supply inter alia depends on the number of units for the uptake and/or means for supply, as they are present in the non-stationary component 30. The recess for the non-stationary component contains the rotatable disc 30. The means for supply 25 of the stationary component 31 are arranged in a way that they can be aligned with the corresponding means for supply and/or units for uptake 25″ resp. 20 of the non-stationary component 30 (for example by rotation). The drill hole 24 shall indicate the position of a means for mounting, here a screw, which, for example, connects two elements of the stationary component resp. of the non-stationary component, respectively (for example the non-stationary component and a means for drive), preferably in interaction with other screws and/or other means for mounting.

The operation of the device of the invention can be exemplified at hand of FIG. 6. In a typical experiment, the components 30 and 31 as well as the appropriate fluid supplies and fluids are adjusted to the appropriate desired parameters, for example temperature (by means of means for adjusting of parameters, not shown in the Figure). By rotation of the component 30, in position A a building block is taken up into the appropriate unit for uptake 20 and is transported to position B. Hereby, the non-stationary component 30 is forwarded continuously with a constant cycle time of, for example, 20 seconds, so that the building block passes through the positions B to F, whereby said positions are overflowed with inert gas, for example N₂, by means of appropriately launched means for supply from the stationary component 31 by means of the ducts 25″, which are formed as meander.

By means of the operating sequence of the next cycle, the building block reaches position G, where it is overflowed analogously with reactive gas. The gas, which flows off from the building block is directed by means of the means for supply 25′ to the analysis device (not shown), and there, an analysis of the reaction products is carried out with a high demand interval. Hereby, within the cycle time of 20 seconds, the products are analyzed and, for example, corresponding deactivation processes are investigated, how they occur, for example, in selected petrochemical processes within very short periods. According to the performance properties of the building block, which were determined, said building block is assigned at the following positions H to J to three different performance classes. Thereby, it is clear that, at any time, in each of the units for the uptake at the positions A to G a building block is present, respectively, that means that with each cycle at position A a new building block is taken up.

Hereby, the device of the invention according to FIG. 6 can be applied to a non-constant cycle time. For example, it would be conceivable charging the positions B to D with three different building blocks starting from position A within three short cycles, for example 1 second, respectively. Afterwards, a prolonged cycle of for example 30 seconds follows, in which the building blocks are overflowed with reactive gas, and achieve a constant operation point. Subsequently, in turn, three short 1 second cycles follow in order to transport the building blocks to the positions E to G. At these positions, the building blocks are kept on to be overflowed with reactive gas with a cycle time of 30 seconds, and all three gas mixtures, which flow off, are directed separately to a device for analysis for the parallel analysis, or also directed separately to three separated devices for analysis. Thus, the performance properties of all three building blocks are analyzed in parallel. Afterwards, in turn, three short cycles follow, in order to assign the building blocks to the different classes, as described above.

FIG. 7 shows a detailed view of the non-stationary component 30 from FIG. 5. Thereby, FIG. 7a is a section through the disc (lateral view) and FIG. 7b is the corresponding top view in direction A, whilst FIG. 7c represents the top view in direction of B. Altogether, the non-stationary component 30 is realized as rotatable disc, as already mentioned with respect to FIG. 5. Said disc has on its radial outer surface units for uptake 20, which are connected with a means for supply 25″, and which can take up a building block 36. Said means for supply are ducts, which are in the form of a meander, as likewise already discussed for FIG. 5, the position of which within the disc can be well identified in the present Figure. With respect to the fine mechanical or micro mechanical manufacture of the ducts, it is preferred producing the rotatable disc 30 from two semi parts, whereby the ducts are inserted half deeply in each disc, and the both semi parts are connected subsequently, for example bonded, so that from the opened ducts a closed duct is formed.

Said ducts go to another means for supply 25, which, for example, can be seen in FIG. 7c, and which protrude there from the drawing plane. Said means for supply are aligned with the corresponding means for supply of the stationary component, as the case may be, by means of other connecting parts, as shown for example in FIG. 5. Finally, in FIG. 7 still the presence of means for mounting 24 is shown in order to indicate the possibility of the connection of said rotatable component with a means for drive, for example an engine with a mandrill.

FIG. 8: FIG. 8 a shows the total view (lateral view) of an embodiment of the device of the invention with a horizontal rotatable body (disc), whereby said body is a non-stationary component 30 in the meaning of the present invention. Thereby, both the disc and the mandrill to be connected therewith rotate. The mandrill is connected with the stationary component 31 by means of a means for mounting 24′, here a ball bearing. As can be seen from the illustration, in turn, the stationary component 31 itself consists of several constituents, which are connected with each other, in particular of the cover plate with the means for supply 25 and 25′. At said cover plate is another means for mounting 24, in this case a pressing spring, which effects that stationary and non-stationary component are connected with each other in a leak-proof and reproducible manner, but, can still be moved mechanically.

Furthermore, within the cover plate of the stationary component is still a means for storing 42, which can be for the supply of building blocks, if the non-stationary disc 30 is turned into the appropriate position, so that unit for uptake 20, see FIG. 8b, and means for storing 42 are stringed with means for supply 25 in a way that the building block can fall into the unit for uptake 20. The advantage of the embodiment with horizontal rotatable body described herein, is that the preferred direction of the gravitation can be used for many operations, so as here the charging. The cover plate is connected with the bottom part of the stationary component by means of locating pins as means for mounting 24. Compared with righted rotatable discs, as further advantages have to be mentioned yet the better accessibility of the individual components, as well as a simpler fluidic sealing.

The non-stationary component, that means the rotatable disc, also consists of two components, namely of the rotatable disc 30 itself as well as of a circular insert 30′ (FIG. 8b), which is arranged therein (or on top). In particular, such an insert has the advantage that in case of contamination and/or reduction of the function of an unit for uptake 20 or a means for supply 25″ not the complete rotatable disc 30 has to be substituted, but only the insert 30′. It is also conceivable segmenting the circular insert, thus, inserting individual platelets into the rotatable disk. In particular, such an exchange of segmented inserts could also be carried out during the continuous testing is continued by using the other inserts.

FIG. 8b shows in detail the circular insert 30′ of the rotatable body 30 with the unit for uptake of a building block 20, a building block 36, a means for supply 25″, which is arranged in an angle, however, which is tethered at the unit for uptake 20 in a manner that all in all a vertical overflowing of the building block 36 is given. The means for mounting 24 is for the fixing of the insert 30′ in the rotatable body 30 and, in the case on hand, is carried out as locating pin. In the case on hand, for example, a total of eight units for uptake 20 are arranged on the circular insert 30′.

FIG. 9 shows a slightly modified embodiment of the device of the invention, which is shown in FIG. 8a. Said embodiment is designed in a manner that it can take up and process building blocks 36, which are in comparison clearly larger. Accordingly, also the different means for supply as well as the units for uptake are designed clearly larger. Furthermore, in difference to FIG. 8a, it was set aside inserting the units for uptake into a separate circular insert.

FIG. 10: FIG. 10a shows a modified embodiment of the embodiment of the device of the invention, which was already shown in FIG. 8, with a horizontal rotatable body (disc), whereby said disc in turn is the non-stationary component 30 in the meaning of the present invention. In this case, in difference to the embodiment of FIG. 8, the unit for uptake is arranged in the center between two means for supply (25 and 25′; are for the supply of fluids, whereby the means for supply 25″ is in the horizontal plane), and which is flowed through horizontally. To said centric position, in which the building block should be arranged, the means for supply 25′″ allows access, that is the building blocks are charged by means of the means 25′″.

Some modifications result also with respect to the stationary component 31. In particular, the means for supply 25, 25′ and 25′″ are partly arranged in an angle. Furthermore, the means for the adjusting of the parameter set P, 27 and 27′, are shown here. The means 27 are thermal elements, which allow measuring the temperature at important positions, for example close to the building blocks. The means 27′ relate to heating candles, which can be inserted into the device, and which allow in interaction with the thermal elements and one means for recording and analysis of data a comprehensive operation and controlling of the temperature within the device.

Furthermore, yet the means for mounting have to be mentioned, here in particular the connection 24, the bearing 24′ as well as the pressing spring 24″. Finally, still a means for power transmission 23 is shown, in this case a gear rim, which conveys the rotatable drive by means of an engine (not shown here).

FIG. 10b shows a simplified illustration of the device of the invention of FIG. 10a in three dimensional assembly and section view.

FIG. 10c shows a three dimensional exploded view of the different elements of the device of the invention corresponding to FIG. 10a, from which the interaction of non-stationary component and stationary component of the device is clarified. Thereby, the non-stationary component 30 is connected with the circular insert 30′ by means of a means for the mounting 24, in which a plurality of units for uptake 20 is located. Furthermore, the means for adjusting of parameters are indicated, in that case means for heating 27 as well as means for measurement of the temperature 27′.

FIG. 11 shows a detailed view (top view) of the upper, stationary component 31 from FIG. 10a. Here, it is a horizontal cover plate with means for supply (25, 25′ and 25′″ as described in FIG. 10) as well as means for mounting 24 (connections) and means for the adjusting of parameters 27 (here: thermal element).

FIG. 12 shows a detailed view of a part of the non-stationary component 30 from FIG. 10: thereby, FIG. 12a is a top view of the unit for uptake 20 of a building block 36 with means for supply 25″, which is overflowed horizontally, and FIG. 12b is an exemplified illustration of an arrangement of eight units for uptake 20 of building blocks on a non-stationary component 30 (here a rotatable body) in the top view. The means for mounting 24 are for the fixing of said body, which are formed here as locating pins.

In the meaning of the present invention, any amount of such units for uptake can be inserted in the rotatable disc, for example 16, 64, 256, or more. Furthermore, it is possible according to the invention that such units for uptake inclusive the corresponding feed-lines are arranged in parallel, that means on different radii, and that thereby, by paralleling, an additional increase of the throughput is enabled.

The FIGS. 12c and 12d show another embodiment of a non-stationary component of the device of the invention, for example as shown in FIG. 10a. Thereby, the means for supply 25″ is designed as a duct, which is formed like a meander, in order to generate a defined pressure loss in case of the flow through with fluids. Said duct can also be arranged inside according to the invention, for example that is to say when the component is constructed from different semi parts. The reaction space consisting of unit for uptake of the building block as well as the means for supply is provided at the inlet and the outlet side with a steadily expanding duct, in order to achieve a good flow around the component. The building block itself is in the middle of the reaction space, whereby it is fixed at this position by means of appropriate pyramidal or cylindrical or otherwise formed recesses within the reaction space. In contrast to the other embodiment, however, no flow through takes place towards the direction of said recess, but a horizontal overflowing of the building block.

FIG. 13 shows an embodiment of the device of the invention, in which as non-stationary component not a rotatable body is inserted, but a body, which can be shifted linearly, in that case the non-stationary component 30 is a “comb” resp. a gate valve. This is for the uptake of preferably one building block 36 per unit for uptake, respectively. For example, the building block is taken from a means for storing 42 (in principle in a similar manner as described with FIG. 4) and is taken up by a unit for uptake 20. For example, said uptake can be supported thereby that by means of the means for supply 25′ vacuum is applied in the stationary component 31, and the building block 36 quasi permeates into the unit for uptake.

For the lead-through of other steps resp. operations the gate valve 30 preferably is operated linearly into x-direction. The operatability of the gate valve 30 for a length L or a multiple of said length, which, preferably, correlates to the distance of the units for uptake 20 towards each other, allows the positioning of the building block 36 at determined positions, for the lead-through of operations, as for example test operations. So, for example, a reaction gas mixture is flowed around a building block upstream of the means for supply 25 and the product gas mixture to be discharged from the reaction space is directed to a means for analysis 81. Thereby, using an IR-transparent window ensures the analysis. Furthermore, in the position upstream of the means for supply 25″ compressed air can be blown into the appropriate positioned unit for uptake in the gate valve 30. If the means for supply, which is located above the means for uptake, has a suitable diameter, as shown here, then, for example, the building block 36 can be blown out within the scope of a classification.

Fundamentally, the charging of the unit for uptake 20 with several building blocks 36 per unit for uptake 20 is likewise conceivable, as well as the charging of all units for uptake 20 of the gate valve 30. For more details with respect to the embodiment of a non-stationary component, which can be operated linearly, reference is made to the application DE 101 59 189.6, the relevant disclosure of which should fully be incorporated here.

An important advantage of the embodiment of the device of the invention in form of a shiftable bar 30, which can be moved linearly relative to a stationary component 31, is, for example, the simple paralleling, and thus a processing rate of the building blocks 36, which again is clearly higher. Such arrangements can be realized and can be run according to the present invention in any number in a serial or parallel manner, what in general also applies to the other shown embodiments of the device of the invention.

FIG. 14 exemplifies different types and embodiments of possible building blocks 36.

FIG. 14a: Here, it concerns to a building block 36, which is in a defined geometric form, for example as a ball. Naturally, different geometric forms are also possible, for example prisms, cylinders, hollow cylinders, hollow balls, pyramids, cotters, rotational paraboloids, ellipsoids, cones or any other rotational solids. In a preferred embodiment, the building blocks comprise a support material, for example a porous or non-porous ceramics. If said support material is porous, then other materials can be inserted into the pores of the material, for example, as it takes place in the synthesis of typical supported catalysts by means of impregnation. In a particular preferred embodiment, therefore, the building block which is represented in FIG. 14a is a typical supported catalyst, which is in the form of a ball.

FIG. 14b: In another embodiment it is possible that the building block 36 consists of a core 35 and at least of one shell 37 around said core 35. In a preferred embodiment the core 35 is an inert material, which serves as support for the potentially active substance. Such building blocks 36 are manufactured by means of coating of cores 35, which are present in a defined geometric form. In a preferred embodiment such a building block 36 is a shell catalyst. In this case, the core is preferably an inert ceramic material, on which a catalytic active material was applied by means of coating processes or by means of a specific method for synthesis, for example a mixed oxide catalyst.

FIG. 14c: In this embodiment, the core 35 of the building block 36 consists of a material, which has a specific property, preferably a physical property, however, which is within the test operation to be carried out inert resp. protected against the attack of fluids, etc. For example, said core 35 can be a magnetic core, in order to allow a transport, the handling or a selection of such a building block 36 by means of the defined application of a magnetic field. Then, preferably, on said core is a first layer 39, which isolates the core 35 from other layers. Then, for example, as outer layers embodiments according to FIG. 14b or also FIG. 14a are possible.

FIG. 14d: This embodiment is an unsupported building block 36, for example a full catalyst, which can be produced in a defined geometric form by means of the application of appropriate methods. Furthermore, in another embodiment, said building block 36 can have a hollow core.

FIG. 14e: For the testing of powdery materials, the building blocks 36 can also be present in a form, which is shown in FIG. 14e. Thereby, the powder 70 is in a housing 72, whereby the powder 70 is supported by a frit or membrane 74 at the bottom of the housing 72, which avoids a discharge of the powder 70 downward. Moreover, according to the invention a passage of the fluid can occur through the frit or membrane 74, whereby a performance property of the powdery material can be investigated in the flow-through with fluids by means of a parameter set P. In said embodiment, preferably, the housing 72 is opened upward, in order to allow inserting the powder. This requires that during the test the building block 36 must be held in such a position that the powder cannot discharge in a non-defined manner. By using such a building block the use of a gate valve as shown in FIG. 13 or a horizontal disc according to FIG. 8 is preferred.

In another embodiment the housing can contain more frits resp. membranes 74 (not only at the bottom of the housing 72) or can completely consist of a material, which is permeable for fluids.

FIG. 14f: In comparison to FIG. 14e, in FIG. 14f a building block 36 is shown, whose housing 72 can be covered after the insertion of a powder 70 with a resealable cover 76. Also, within the cover 76, is a frit, which is permeable for fluids, or a membrane 74, which is formed in a manner that a discharge of the powder 70 can be avoided. In another embodiment, the housing 72 as well as the cover 76 can provide other frits resp. membranes, or can completely consist of a material, which is permeable for fluids.

FIG. 14g: shows a building block 36, which has at least one, preferably two frits, which are permeable for fluids, or membranes 74, whereby said building block 36 is sealed tightly, so that the powder 70 being therein cannot discharge. Therefore, the powder 70 is inserted either into the housing 72, which is still open, and afterwards said housing is sealed materially or otherwise, for example by bonding, or the powder is directly synthesized from the fluid phase in the housing 72. In another embodiment, the housing 72 can contain more frits resp. membranes 74 or can also consist completely of a material, which is permeable for fluids.

FIG. 14h: A special embodiment of the building block 36, which is shown in FIG. 14g, is shown in FIG. 14h. Here, the complete housing 72 consists of a membrane, which is permeable for fluids. In said housing 72 the powder is enclosed. Preferably, the manufacture of such a building block 36 is carried out in a manner that a powder 70 is formed with a matrix-forming material to a shaped body, for example graphite, and subsequently a porous, resistant membrane is synthesized on said shaped body. In a subsequent thermal treatment, the matrix-forming material is burnt so that the housing 72 and the powder 70 remain as residue. In another embodiment, a high porous shaped body, which, for example, consists of graphite, is impregnated with different precursor solutions, for example by means of the process, which is described in the DE-A 100 59 890. Subsequently, on said shaped body a porous, resistant membrane is synthesized. In case of a thermal treatment, the material of the shaped body is removed and the housing 72 as well as a fine-grained powder 70 from the synthesis remain as residue within the pores of the shaped body.

In general, the building blocks 36, which are represented in FIG. 14, are formed in a manner that they can have a coding, which allows a clear identification of the building block 36 as well as a tracing of its path in a synthesis and/or test process according to the present invention. For more details for the production and application of such codings reference is made to the relevant descriptions in the DE-A 101 17 275 and in the DE-A 101 17 274.

In particular, the building blocks 36, which are shown in the FIGS. 14e to 14h, can also have means for saving the position, whereby the coding also can be used as means for the saving of the position resp. the identification of the position of the building blocks 36. With respect to the means for saving the position or identification of the position reference is made to the remarks, which are given in the DE-A 101 17 274 and the DE-A 101 17 275, whereby, relating to said remarks, both applications are fully incorporated in the context of the present application.

FIG. 15 shows a special embodiment of the building blocks 36 and their arrangement in the reaction space. Thereby, the material to be tested is in powder form within a container, which is permeable for fluids. The reaction space between the stationary and the non-stationary component is now formed in a manner, that it can take up exactly one building block in the unit for uptake 20. Additionally, in FIG. 15a, the means for supply 25 and 25′ are provided with pyramidal or cylindrical widenings, in order to ensure a fluidic favorable transition between means for supply and building block.

In FIG. 15b the means for supply in the stationary component 31 is designed in a manner, that by means of said means for supply building blocks 36, thus containers, can be fed in, that means there is a means for storing 42. Thereby, in said particular embodiment, the building blocks are already in the correct orientation and arrangement with respect to the testing, which can be performed in the present case in a simple manner by a suitable means for separating according to the invention.

FIG. 15c shows another particular embodiment of the reaction space for the uptake of a building block with a cylindrical enlargement of the cross section at the upper end. Thereby, the unit for uptake of the building block 20 is formed according to the form of the building block. By means of the cylindrical form at the upper end of the building block and by means of the form of the cavity, which is also cylindrical tapered, a sealing surface between building block and cavity is formed by inserting the building block into the cavity. Thereby, it is achieved that the building blocks, which are inserted by means of the means for supply, preferably are flowed through and are not flowed around.

FIG. 16 shows an embodiment of the device of the invention, in which as non-stationary component 30 a body, which can be shifted linearly, is inserted in a “comb” resp. a gate valve, and the device is not for the testing of building blocks, but for the conditioning and/or manufacture thereof. The gate valve enables the uptake of preferably one building block 36 per unit for uptake, respectively. For example, this is accomplished at the station S1. For example, the building block is taken from a means for storing 42 (in principle in a similar manner as discussed in FIG. 13) and is taken up by an unit for uptake 20. For example, said uptake can be supported thereby, that by means of the means for supply 25′ vacuum is applied in the stationary component 31, and the building block 36 permeates into the unit for uptake.

Preferably, for the lead-through of more steps resp. operations, the gate valve 30 is shifted linearly in x-direction. The shiftability of the gate valve 30 for a length L or a multiple thereof, which preferably corresponds to the distance of the units for uptake 20 towards each other, enables the positioning of the building block 36 at determined positions, for the lead-through of operations, as for example the metering and/or pipetting of at least one constituent (for example by any type of known pipetting robots, piezo-driven nano-metering devices, etc., optionally also with a plurality of pipetting heads in parallel) in station S2 by means of the means for supply 25 on the building block in its unit for uptake. In the station S3, by means of the feeding of the corresponding gases and by means of a means for the adjustment of parameters P 27, here a heating, a drying and/or a calcination of the building blocks takes place, which were changed chemically and/or physically in the station S2.

Furthermore, in the station S4 compressed air can be supplied into the appropriate unit for uptake in the gate valve 30. If the means for supply, which is positioned above the unit for uptake, as shown here, has a suitable diameter, then the building block 36 can be blown out. Finally, in the station S5, the unit for uptake, which is clear now, can be rinsed by means of supplying suitable agents, and can be dried subsequently in station S6 according to the proceeding for station S3. Herewith, the unit for uptake is prepared to be set back to the position of station 1, in order to take up a new building block 36, without that said building block would be contaminated by the constituents, which were used before.

FIG. 17 shows a schematic illustration of a particular embodiment of the device of the invention, which is arranged as shiftable bar for the testing of liquid batches. In the mentioned view, the device of the invention has in total four stations S1 to S4, which are formed by the stationary components 31 as well as by the non-stationary component 30. Thereby, the unit for uptake 20 in the non-stationary component is formed in a manner that it is suitable for a testing of batches of building blocks, which are in fluid form resp. are suspended in fluids. Furthermore, in that case the unit for uptake 20 does not possess a means for supply, which would allow a passage to the stationary component 31 at the bottom, because said function is not necessary resp. not reasonable in the present particular embodiment.

In the present case, for example, the device of the invention is run in a way that at station S1 by means of a means for supply 25, which, for example, can be positioned in xyz-direction, for example a commercial available metering robot with appropriate pipette, a building block 36 in fluid form is metered into the means for uptake 20 of the non-stationary component 30. Subsequently, component 30 is shifted by means of a means for drive (not shown in the drawing) for the length L in x-direction, so that the building block is now in station S2. At said station, the stationary components 31 have means for the adjustment of parameters, for example a heating 27, whereby a tempering of the building block is achieved within the test period. By means of said tempering, optionally in combination with another supply of substances by means of the means for supply 25 (not shown at station S2), a reaction of the building block in the unit for uptake occurs. After a certain reaction period, which can be determined user-defined or can be determined by the reaction progress, the component 30 in turn is shifted for the length L in x-direction, so that the building block 36 is transported to the station S3.

Here, now, analogous to station S1, a sample of the building block 36 can be taken by means of a suitable means for supply, and can be fed by means of an appropriate device for transport to a means for analysis 81. Afterwards, in turn, the non-stationary component 30 is shifted, so that the remaining quantity of the building block at station S4 can be rinsed from the unit for uptake. This is carried out by means of appropriate means for supply 25 and 25′, which, for example, enable a feeding of solvent and therewith a rinsing of the unit for uptake. Additionally, the stationary component 31 has a heating at station S4 (means for adjustment of parameters) 27, by means of which the unit for uptake can be dried after the rinsing and cleaning, for example under a stream of inert gas by means of the means for supply 25 and 25′.

Therewith, as a result of the treating steps at station S4, a cleaned and dry unit for uptake 20 is provided for the further process. Subsequently, the non-stationary component 30 can now be shifted in negative x-direction for the length 3×L, in order to take up the next building block for the testing according to the invention.

Now, in the following, preferred embodiments are exemplified without restricting the general disclosure of the description in any form:

### EXAMPLE 1

A preferred embodiment of the present invention is to be specified by means of the following example. At first, all aqueous impregnation solutions, which are used for the manufacture in the example, are listed (concentration and applied volume):

| Precursor | ratio | molarity | dispensed volume |
|---|---|---|---|
| V₂(C₂H₄O₄)₅/H₃PO₄ | (1:1) | 0.5M | 1000 μl |
| Ni(NO₃)₃ | | 2M | 500 μl |
| Co(NO₃)₃ | | 3M | 500 μl |
| Mg(NO₃)₂ | | 2.85M | 1000 μl |
| Cr(NO₃)₃ | | 1.4M | 500 μl |
| Rh(NO₃)₃ | | 1.25M | 1000 μl |
| AgNO₃ | | 2M | 1000 μl |

In a 1^{st} step (1^{st} generation), 500 μl V-solution are pipetted to 1 g γ-alumina beads (CONDEA, 1 mm diameter, approximately 0.7 g weight per bead) in a porcelain bowl uniformly distributed over the area. After drying (2 h at 80° C. in a drying oven) and intensive mixing, the quantity is cut into halves and transferred into two new porcelain bowls; the first half of the beads is charged with cobalt solution (=2^{nd} generation V—Co), the second half with nickel solution (=2^{nd} generation V—Ni). Both quantities of the 2^{nd} generation are combined on a new bowl, stirred, and after drying (2 h at 80° C. in a drying oven) coated with a magnesium solution (=3^{d} generation V—Co—Ni—Mg). Subsequently, the stirred portion of support beads is dried (2 h at 80° C. in the drying oven), cut into halves again, and distributed on 2 small bowls; the one half is provided with a rhodium precursor solution (=4^{th} generation V—Co—Ni—Mg—Rh), the second with a chromium solution (=4^{th} generation V—Co—Ni—Mg—Cr). Both quantities are again dried and then combined, mixed intensively and are provided in the last step with the silver solution (=final generation V—Co—Ni—Mg—Rh—Cr—Ag). Finally, another drying step is carried out: the final generation is treated for 12 h at 80° C. in a drying oven, and is subsequently calcined at 500° C. under nitrogen in a muffel furnace.

The testing of the produced materials for performance properties is carried out subsequently in a device of the invention according to FIG. 1 and FIG. 6. First of all, the preparation of the process is carried out by means of a web-based graphical software, which was developed specially, whereby a selection of the building blocks to be tested from a data bank as well as the assignment of appropriate test parameters takes place. Subsequently, the experimental test design is saved in XML-format and is transferred to the control of the device. Subsequently, the complete test process is automated by means of a personal computer with appropriate graphic software for the operation of the different constituent parts of the device: tempering, metering of the educts by means of flow rate controllers resp. vaporazing of liquid educts in controlled vaporizers or saturators, positioning of the non-stationary component 30 by means of an engine drive, control and recording of data by means of the device for analysis (mass spectrometer), control of the corresponding magnetic valves, etc. Thereby, the control of the test procedure is determined by means of selection and loading of the XML-test design. In turn, the recording and saving of the detected test data is carried out by means of a XML-data format of a proprietary development, and is carried out subsequently in an appropriate data bank.

After the calcination, all building blocks (beads) 36 are transferred to the reservoir 42 (FIG. 1). During the storing the complete material library is kept under a stream of nitrogen of 200 ml/min at 200° C. The wheel analogous to FIG. 6 with, for example, 10 positions A-J successively takes up beads out from the reservoir. At the first position A of the wheel, an incoming flow with fluid from the gas supply 1 takes place. Here, nitrogen (2 ml/min, 350° C.) is flowed against the bead and the bead is heated. However, position A optionally allows sucking the bead from the reservoir by means of vacuum (membrane pump) to position A in the wheel. By turning the wheel for 45° (cycle: 10 seconds) the bead reaches the conditioning positions B to F. Here, a fluid mixture (1% toluene in synthetic air) with a total stream of 2 ml/min is flowed against said beads by means of the means for supply 25 at 350° C. (While continuing turning the wheel, position A of the wheel is filled with the next bead). Target reaction is the partial oxidation of toluene to benzaldehyde in the gas phase with synthetic air. Position H is the measurement position of the wheel, the measurement is carried out under the analogous conditions as at the conditioning positions B-F by means of mass spectroscopic analysis (FIG. 1, 81).

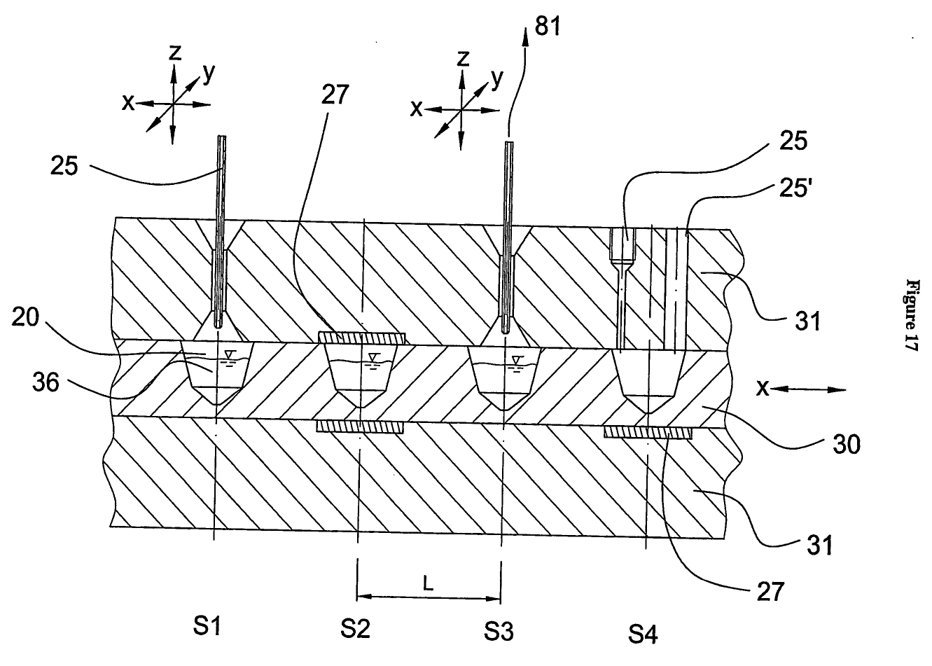

A commercial available mass spectrometer with sample capillary (“nozzle pipe”, Balzers QMS 200) analyses the fluid stream at the measurement position within 7 s. By means of the ion stream for selected m/z-ratios, the selection of the materials takes place at the classification positions H to J in FIG. 6. Three products were exemplarily selected with the corresponding m/z-ratios: m/z=44 specific for CO₂, m/z=106 specific for benzaldehyde and m/z=123 characteristic for benzoic acid. At position H (FIG. 6) all beads are discharged, which are prospective for the target reaction (toluene to benzaldehyde), which thus have for m/z=106 a value greater than 5*10⁻¹¹ mA. At position I of the wheel (FIG. 19) all materials are “sorted off”, whose CO₂-signal (m/z=44) is greater than 2*10⁻⁷ mA, thus primary burning the toluene totally, or whose signal for benzoic acid exceeds the value of 1*10⁻¹⁰ mA of the peak at m/z=123. At the last position all remaining beads are “collected”. Under these conditions, said beads neither have a significant activity towards the target product nor to CO₂. Subsequent to said rating of the materials according to their performance properties (catalytic activity and catalytic selectivity) the materials from position H are characterized by means of elementary analysis by means of XRF (X-ray fluorescence spectroscopy). Thereby, the result for ten materials of the class H yields, which form benzaldehyde above a specific threshold value (m/z=106>5*10⁻¹¹ mA), which is given in the following table.

TABLE 1
Results of the μ-EDX for 10 materials of class H
Final generation: V—Co—Ni—Mg—Rh—Cr—Ag

| | oxides: | wt % |
|---|---|---|
| 1^{st} bead | Al | 92.33 |
| | V | 2.5 |
| | Co | 0.23 |
| | Ni | 1.78 |
| | Mg | 0.96 |
| | Rh | 0.77 |
| | Cr | 0.74 |
| | Ag | 0.03 |
| 2^{nd} bead | Al | 91.88 |
| | V | 2.13 |
| | Co | 0.44 |
| | Ni | 1.46 |
| | Mg | 1.78 |
| | Rh | 0.71 |
| | Cr | 1.98 |
| | Ag | 0.01 |
| 3^{d} bead | Al | 96.10 |
| | V | 1.99 |
| | Co | 0.53 |
| | Ni | 1.22 |
| | Mg | 1.62 |
| | Rh | 0.64 |
| | Cr | 2.13 |
| | Ag | 0.05 |
| 4^{th} bead | Al | 97.39 |
| | V | 1.31 |
| | Co | 0.3 |
| | Ni | 1.54 |
| | Mg | 1.34 |
| | Rh | 0.39 |
| | Cr | 1.02 |
| | Ag | 0.11 |
| 5^{th} bead | Al | 92.99 |
| | V | 2.19 |
| | Co | 0.71 |
| | Ni | 0.63 |
| | Mg | 1.14 |
| | Rh | 0.57 |
| | Cr | 1.83 |
| | Ag | 0 |
| 6^{th} bead | Al | 96.58 |
| | V | 1.82 |
| | Co | 0.36 |
| | Ni | 1.23 |
| | Mg | 1.11 |
| | Rh | 0.44 |
| | Cr | 1.57 |
| | Ag | 0.07 |
| 7^{th} bead | Al | 97.96 |
| | V | 1.11 |
| | Co | 1.04 |
| | Ni | 1.13 |
| | Mg | 0.39 |
| | Rh | 0.31 |
| | Cr | 0.79 |
| | Ag | 0 |
| 8^{th} bead | Al | 95.99 |
| | V | 1.85 |
| | Co | 0.47 |
| | Ni | 0.65 |
| | Mg | 1.95 |
| | Rh | 0.66 |
| | Cr | 0.61 |
| | Ag | 0.23 |
| 9^{th} bead | Al | 97.18 |
| | V | 1.14 |
| | Co | 0.41 |
| | Ni | 1.26 |
| | Mg | 0.26 |
| | Rh | 0.34 |
| | Cr | 0.81 |
| | Ag | 0.13 |
| 10^{th} bead | Al | 97.65 |
| | V | 1.33 |
| | Co | 0.61 |
| | Ni | 0.34 |
| | Mg | 0.76 |
| | Rh | 0.43 |
| | Cr | 0.19 |
| | Ag | 0.07 |

### EXAMPLE 2

At first, all aqueous impregnating solutions are listed, which are used for the example (concentration and applied volume):

| precursor | ratio | molarity | dispensed volume |
|---|---|---|---|
| V₂(C₂H₄O₄)₅/H₃PO₄ | (1:1) | 0.5M | 1000 μl |
| Ni(NO₃)₃ | | 2M | 500 μl |
| Co(NO₃)₃ | | 3M | 500 μl |
| Mg(NO₃)₂ | | 2.85M | 1000 μl |
| Cr(NO₃)₃ | | 1.4M | 500 μl |
| Rh(NO₃)₃ | | 1.25M | 1000 μl |
| AgNO₃ | | 2M | 1000 μl |

In a 1^{st} step (1^{st} generation), 500 μl V-solution are pipetted to 1 g γ-alumina beads (CONDEA, 1 mm diameter, approximately 0.7 g weight per bead) in a porcelain bowl uniformly distributed over the area. After drying (2 h at 80° C. in a drying oven) and intensive mixing the quantity is cut into halves and transferred into two new porcelain bowls; the first half of the beads is charged with cobalt solution (=2^{nd} generation V—Co), the second half with nickel solution (=2^{nd} generation V—Ni). Both quantities of the 2^{nd} generation are combined on a new bowl, stirred, and after drying (2 h at 80° C. in a drying oven) coated with the magnesium solution (=3^{d} generation V—Co—Ni—Mg). Subsequently, the stirred portion of support beads is dried (2 h at 80° C. in the drying oven), cut into halves again, and distributed on 2 small bowls; the one half is provided with a rhodium precursor solution (=4^{th} generation V—Co—Ni—Mg—Rh), the second with a chromium solution (=4^{th} generation V—Co—Ni—Mg—Cr). Both quantities are again dried and then combined, mixed intensively and are provided in the last step with the silver solution (=final generation V—Co—Ni—Mg—Rh—Cr—Ag). Finally, another drying step is carried out: the final generation is treated for 12 h at 80° C. in a drying oven, and is subsequently calcined at 500° C. under nitrogen in a muffel furnace.

After the calcination all building blocks (beads) are transferred to a reservoir (not shown in FIG. 17). During the storing the complete material library is kept at 200° C. under a nitrogen flow of 200 ml/min. In a station S0 (not shown in FIG. 17) a single bead is dispensed into a unit for uptake 20 as well as a single magnetic stir bar in the appropriate size. As liquid phase test reaction the oxidation of toluene to benzaldehyde by means of tert.-butyl hydroperoxide was selected. Thereby, as by-products tert.-butanol and H₂O yield. After positioning of the component 30 by shifting into x-direction to the position S1 the subsequent feeding of 400 μl toluene and 100 μl tert.-butyl hydroperoxide (TBHP, 80%) takes place by means of device 25, for example by means of the cone point of the pipette of a commercial available metering robot. After the charging with educts, the component 31 is shifted further into x-direction to the position S3, where a tempering by means of the means 27 as well as the mixing by means of an external magnetic stirrer (not shown in FIG. 17), which in position S2 drives from bottom the magnetic stir bar, takes place. After a reaction time of 2 min at 85° C. at position S2, the component 31 is shifted for the length L into x-direction to position S3. At position S3 it is easily possible taking a liquid sample (50 μl) of the reaction mixture by means, for example, the cone point of the pipette of a commercial available metering robot, and to feed said sample to the analysis device 81, in our case to a GC/MS. In the analysis device 81 (for example GC/MS) a chromatographic separation of the liquid sample is carried out and each ingredient is identified by means of mass spectroscopy. Therewith, a qualitative detection for the target product benzaldehyde can be carried out quickly. After the transport of the component 31 to position S4 the complete reaction chamber 20 is rinsed with acetone by means of the supply 25. By means of the outlet 25′ liquid and solid ingredients of the reaction solution are rinsed out and the reaction chamber is cleaned. A terminating blowing-through with nitrogen restores the initial state of the chamber 21, so that after the shifting of component 31 to position S0 with a renewed charging with solid catalyst bead and means for stirring (“magnetic stir bar”), the sequence of the reaction steps of S0 to S4 can be run again.

It can be noted as a qualitative result of our example that catalysts with a high content of vanadium qualitatively supply the best results for the formation of benzaldehyde within the manufactured materials.

### EXAMPLE 3

Manufacture of building blocks by means of the device of the invention

For the manufacture of a catalyst library according to a specific split & pool method a device according to the invention was used according to FIG. 16. Thereby, the shiftable bar 30 was produced from a high-grade steel bar with a thickness of 4 mm and the units for the uptake 20 as well as the ducts, which are aligned continuously downward, were produced by means of microstructure techniques. Thereby, the units for uptake 20 were produced in an arrangement of 16×4 units, in order to carry out serially 16 treating steps into x-direction, respectively, as well as parallel (into y-direction) 4 treating steps (lines), respectively. Therewith, the device has four stations S1 to S6, respectively, in the stationary component 31. At the position S1, one support grain for catalyst 36 (Al₂O₃-bead, 1 mm diameter, Sasol) from the collective reservoir 42 was inserted for all four lines in the unit for the uptake 20 in the parallel production lines, respectively, supported by applying vacuum at the means for supply 25′. The beads were transported to station S2 by means of automatic, computer controlled shifting of the bar 30. There, by means of a special metering robot (Nanoplotter, firm GeSIM, GroBerkmannsdorf, Germany), four different concentrated precursor solutions (Rh(NO₃)₃) were applied onto the different beads simultaneously by means of a four fold pipetting head, which result by means of incipient wetness in the following metal contents:
Line 1: 0.1% Rh
Line 2: 0.3% Rh
Line 3: 0.8% Rh
Line 4: 1.5% Rh

After a residence time of 20 s, a transport to station S3 took place, where by means of a local heater 27 a drying of the beads at 80° C. takes place. After 20 s (in which time already the impregnation of the next support in the subsequent uptake was carried out), it was positioned to station S4, and the impregnated, dried beads were discharged per line into a collective ceramic collecting-container. After another cycle into x-direction the unit for uptake 20 was rinsed with acetone at station S5, and subsequently dried at station S6 at 80° C. under a stationary flow with N₂. By means of another cycle into x-direction with a cycle time of 20 s within one line, a total of 16 beads passes through one impregnation step with subsequent drying. Therewith, as a result, 16 identical Rh-carrying beads were produced per line, respectively.

Subsequently, the bar 30 was positioned in negative x-direction backward to the starting point, and, subsequently, 16 beads were treated in an identical manner per bar, respectively. Said procedure was repeated, until a total of 512 beads per bar was produced. After a calcination of the beads at 450° C., the beads of the four lines are mixed and, in turn, are subsequently applied to the reservoir 42. In said synthesis step now a second element, Ni (precursor: Ni(NO₃)₃) was applied in the same manner for 512 beads per line, respectively, in the same concentration rates (0.1%, 0.3%, 0.8%, 1.5%) as mentioned above. After a renewed calcination and mixing, the synthesis steps subsequently were also carried out with the elements Co and Ag (precursor: Co(NO₃)₃ resp. AgNO₃).

By means of said procedure a split & pool library could be carried out completely automated in a simply manner. Thereby, the characteristic is that an individual synthesis step can be carried out at a single bead and, therewith, as the case may be, said synthesis step can be carried out clearly more reproducible. Furthermore, said arrangement is also reasonable for the manufacture of numerical small libraries, because also a counting and sorting of the elements takes place directly. With an extended paralleling, that means an extension of the number of parallel synthesis lines, thereby, the rate can be clearly increased. Naturally, it is furthermore evident, that the precursors, which are fed at position S2, can be changed arbitrarily in dependence on the time with respect to concentration, type and quantity.

### REFERENCE NUMERALS

20—unit for uptake

23—means for power transmission

24—means for mounting

25—means for supply

26—means for drive

27—means for adjusting of parameters

28—branching-off of exhaust gas

29—means for fluidic sealing

30—non-stationary component

31—stationary component

32—single bead reactor

35—core

36—building block

37—bowl

38—central cavity

39—layer

42—means for supply

70—powder

72—housing

74—membrane

76—cover

81—means for analysis

82—IR-transparent window

83—magnetic valve
PIC—Flow Indication Control
TIC—Temperature Indication Control
CIC—Concentration Indication Control

1-23. (canceled)

24. Device for the continuous testing of at least two building blocks, characterized in that the device comprises at least the following constituent parts:
(i) at least one spatially stationary component with at least one means for supply;
(ii) at least one spatially non-stationary unit which can be shifted along a space axis or is a body, which can be rotated around an axis, or a combination of both;
(iii) at least one unit for the uptake of a building block, the building block being solid;
(iv) at least one means for the transport of a building block between two spatially different positions inside of the device;
wherein the position of at least one building block relative to the at least one other building block changes during the testing and wherein the device comprises a reaction space, whereby the reaction space is a combination of at least one unit for uptake with at least one other constituent part of the device of the invention.

25. Device as claimed in claim 24, characterized in that during the testing the geometry of the reaction space changes, whereby the reaction space is a combination of at least one unit for uptake with at least one other constituent part of the device of the invention.

26. Device according to claim 24, characterized in that during the testing a property change of at least one building block is induced, whereby said property change can be of chemical, physical or physical-chemical nature.

27. Device according to claim 24, characterized in that it contains at least one other means selected from the following group:
(i) means for the analysis of at least one performance property;
(ii) means for the storing of at least two building blocks;
(iii) means for the selection of at least one building block;
(iv) means for the recording and analyzing of data;
(v) means for the classification of at least one building block;
(vi) means for the mounting;
(vii) means for the power transmission;
(viii) means for the drive;
(ix) means for the adjustment of parameters P;
(x) means for the removal of subsequent products or by-products;
(xi) means for the fluidic sealing;
whereby at least two of said means can be applied in arbitrary permutation and repetition or permutation or repetition.

28. Device according to claim 27, characterized in that the at least one means for analysis is selected from the following group comprising: infrared thermography, mass spectroscopy, chromatographic techniques like GC, LC, HPLC, micro-GC; rapid-GC, dispersive FTIR-spectroscopy, microwave-spectroscopy, Raman-spectroscopy, NIR, UV, UV-VIS, NMR, ESR, GC-MS, infrared-thermography/Raman-spectroscopy, infrared-thermography/dispersive FTIR-spectroscopy, color detection with chemical indicator/MS, color detection with chemical indicator/GCMS, color detection with chemical indicator/dispersive FTIR spectroscopy, photo acoustic analysis, electronic or electrochemical sensors as well as tomographic NMR-, ESR-methods, as well as any combinations of at least two of the before-mentioned means for analysis.

29. Device according to claim 24, characterized in that at least one building block is a body, whose maximum radius, measured from the geometric balance point of said body, is between 1 mm and 20 cm.

30. Device according to claim 24, characterized in that at least one building block is a substantially ball-shaped body with a diameter of from 100 μm to 2 cm.

31. Device according to claim 24, characterized in that at least one of the following elements: restrictor, that means pressure loss element or pressure equidistributor, membrane, connecting piece, sealing unit is (i) in the unit for the uptake or (ii) in a means for supply or (iii) in a reaction space or in any combination of (i) to (iii).

32. Device according to claim 24, characterized in that the building block in the unit for uptake or the unit for uptake is positioned for the interaction with at least one means for supply in a manner that a fluid either overflows, flows around and/or flows against said building block horizontally or vertically.

33. Device according to claim 24, characterized in that the transport or the selection of a building block or the transport and the selection of a building block takes place according to at least one method selected from the following group: pneumatic transport methods, inclusive applying overpressure or vacuum, mechanic moving, moving by means of mechanic elements, optical forceps, sound fields, electrostatic methods, magnetic methods, piezo-elements, gravitation.

34. Device according to claim 33, characterized in that the mechanic elements are selected from the following group comprising: wheels, combs, conveyer belts, screws, “revolving doors”, pickers, pincers, metering devices.

35. Device according to claim 24, characterized in that as at least one building block a container is applied, which contains at least one powdery material.

36. Device according to claim 35, characterized in that the container has at least one of the following features: (i) the container is provided with a coding, (ii) the container is provided with at least one membrane or at least one frit, (iii) the container is sealable, (iv) the powder has been generated within the container.

37. Device according to claim 24, characterized in that the non-stationary component is moved in a manner that it moves in specific intervals with constant rate, while it rests in other specific intervals.

38. Device according to claim 24, characterized in that the means for supply consist of ducts with polyhedral resp. circular cross section area, whereby the cross section area can change along the length of a duct, for example can be tapered or it can remain the same.

39. Device according to claim 24, characterized in that the means for supply can serve for the supply as well as for the removal of (i) fluids, (ii) building blocks, (iii) radiation, as well as elements for the pressure control, meaning pressure reducer, or in case of a plurality of units for the uptake of a building block, which are linked together, also as pressure (equi)distributor.

40. Device according to claim 24, characterized in that it has at least one means for the fluidic sealing at at least one position between a stationary and a non-stationary component, and that said means for fluidic sealing is selected from the following group comprising: pressing of polished or otherwise treated surfaces, in particular of metal surfaces, the use of seals, seal rings, in particular of O-rings, metal rings, graphite, lubricants, teflon.

41. Device according to claim 24, characterized in that at least two of said devices are arranged parallelly or serially or parallelly and serially.

42. Use of a device according to claim 24 in high-throughput materials research, in particular in catalyst research.

43. Catalyst comprising at least vanadium, obtained by the use of a device according to claim 24.

44. Device according to claim 24, characterized in that it is used for the continuous conditioning and manufacture or continuous conditioning or manufacture of building blocks.

45. Device according to any one of claim 24 for the selection of at least one building block from a set of at least two building blocks, characterized in that (i) the building blocks are in a means for storing, which (ii) can be linked with a means for the uptake by means of a movable bar, whereby (iii) the bar can be moved forward by means of a means for drive in a manner that (iv) the building block in the unit for uptake is linked with two means for supply, whereby (v) the one means for supply transports the building block into the other means for supply by means of a fluid flow, which is caused by a pressure difference, and (vi) said other means for supply is linked to a device according to one of the preceding claims.
